(19) United States
(12) Patent Application Publication
(10) Pub. No.: US 2026/0338397 A1
(43) Pub. Date: Oct. 29, 2026

(54) AIR CONDITIONER

(71) Applicant: SAMSUNG ELECTRONICS CO., LTD., Suwon-si (KR)

(72) Inventors: Sangmo KANG, Suwon-si (KR); Myungsoo KANG, Suwon-si (KR); Hyongsoo NOH, Suwon-si (KR); Joonoh SHIN, Suwon-si (KR); Doyoung KIM, Suwon-si (KR); Byungghun KIM, Suwon-si (KR); Wooseog SONG, Suwon-si (KR)

(73) Assignee: SAMSUNG ELECTRONICS CO., LTD., Suwon-si (KR)

(21) Appl. No.: 19/690,682

(22) Filed: May 28, 2026

Related U.S. Application Data
(63) Continuation of application No. PCT/KR2024/017570, filed on Nov. 8, 2024.

(30) Foreign Application Priority Data
Dec. 27, 2023 (KR) 10-2023-0193734
Mar. 15, 2024 (KR) 10-2024-0036531

(51) Int. Cl. F24F 8/192; F24F 11/88; F24F 13/08; F24F 13/20

(52) U.S. Cl. CPC F24F 8/192; F24F 11/88; F24F 13/08; F24F 13/20

(57) ABSTRACT

An air conditioner includes: an electrostatic precipitator including a blowing fan, a dust collecting electrode, a discharge electrode configured to emit electrons, and extending in a first direction, and an electric field induction electrode grounded to form an electric field with the discharge electrode, and a housing which accommodates the blowing fan and the electrostatic precipitator. The housing includes a first surface, a second surface, a third surface, and a fourth surface , wherein a suction port is formed on the first surface, the second surface, the third surface, and the fourth surface, and based on a distance from one end of the discharge electrode to the suction port in the first direction being a, and a distance from the discharge electrode to the suction port in a second direction different from the first direction being b, a and b can satisfy the following relational expression. 0.3＜ a/b ＜1

### CROSS REFERENCE TO THE RELATED APPLICATION

This application is a continuation application, filed under 35 U.S.C. §111(a), of International Application PCT/KR2024/017570 filed Nov. 8, 2024, and is based on and claims priority under 35 U.S.C. §119 to Korean Patent Applications No. 10-2023-0193734, filed on Dec. 27, 2023, and Korean Patent Applications No. 10-2024-0036531, filed on Mar. 15, 2024 in the Korean Intellectual Property Office, the disclosures of which are incorporated by reference herein in their entireties.

### TECHNICAL FIELD

The disclosure relates to an air conditioner, and more specifically, to an air conditioner including an electrostatic precipitator.

### BACKGROUND ART

In enclosed spaces such as homes, rooms, shopping malls, factories, and offices, high- concentration aerosols may harm people's health. Such aerosols may be generated by smoking, cooking, cleaning, welding, contact grinding, and the like in confined spaces.

An electrostatic precipitator is a device for removing such aerosols and may be used in an air conditioner having an air purification function.

An electrostatic precipitator may include a charging portion that charges aerosols in the air through discharge, and a dust collection portion that includes a high-voltage electrode and a low-voltage electrode and collects the aerosols charged by the charging portion.

### Disclosure

### Technical Problem

One aspect of the disclosure provides an air conditioner having improved charging efficiency and dust collection efficiency.

The technical objectives of the disclosure are not limited to the above, and other objectives that are not described above will be clearly understood by those skilled in the art from the above detailed description.

### Technical Solution

An air conditioner according to one aspect of the disclosure includes: a blowing fan; an electrostatic precipitator including dust collection electrodes configured to collect aerosols from air blown by the blowing fan, a discharge electrode configured to emit electrons, located upstream of the dust collection electrode, and extending in a first direction, and a field-inducing electrode grounded to form an electric field with the discharge electrode and located upstream of the discharge electrode; and a housing configured to accommodate the blowing fan and the electrostatic precipitator, wherein the housing includes: a first surface; a second surface opposite to the first surface; a third surface connecting the first surface and the second surface; and a fourth surface connecting the first surface and the second surface and opposite to the third surface, wherein an inlet is formed in each of the first surface, the second surface, the third surface, and the fourth surface, and based on a distance in the first direction from one end of the discharge electrode to the inlet being a, and a distance in a second direction different from the first direction from the discharge electrode to the inlet being b, a and b may satisfy the following relation:
0.3 < a/b < 1

The air conditioner may further comprise: an air guide extending in the first direction, the air guide being configured to deflect air drawn into the housing in the second direction through the inlet.

The electrostatic precipitator may include a printed circuit board electrically connected to the discharge electrode above the discharge electrode, and based on a vertical distance from the printed circuit board to a lower end of the air guide being a, and a horizontal distance from the printed circuit board to the air guide being b, a and b satisfy the following relation.
0.3 < a/b < 1

The inlet may include: a first inlet; and a second inlet, wherein the housing may further include: a blowing panel including the first inlet through which air moved by the blowing fan flows; and a case configured to accommodate the electrostatic precipitator and including the second inlet through which air that has passed through the first inlet flows, and wherein the air guide extends from an inner wall of the case forming the second inlet toward the second inlet.

The air guide may extend from the inner wall of the case forming the second inlet toward an inside of the case in a downwardly inclined manner.

The air guide may have an angle of 15 degrees to 70 degrees with respect to a horizontal direction.

The dust collection electrode may be disposed above the discharge electrode and the field-inducing electrode; the field-inducing electrode is disposed below the discharge electrode; the discharge electrode is disposed above the lower end of the air guide; and the printed circuit board is disposed above the discharge electrode.

The air guide may be a first air guide, and the air conditioner further includes a second air guide disposed in the housing and configured to guide air drawn into the housing in the second direction through the inlet, toward the discharge electrode.

The second air guide may include: a first guide portion inclined with respect to the second direction to deflect air drawn in the second direction, and a second guide portion inclined with respect to the second direction in a direction different from a direction of the first guide portion to deflect air drawn in the second direction.

The first direction may be a vertical direction and the second direction is a horizontal direction.

The electrostatic precipitator may further include a ground electrode disposed above the discharge electrode and below the dust collection electrode such that ions are attached the ground electrode.

The ground electrode may be a first ground electrode, and the electrostatic precipitator further includes a second ground electrode disposed below the field-inducing electrode.

The housing may further include a case configured to accommodate the electrostatic precipitator and including the inlet, and the air guide is configured such that air introduced into the case through the inlet moves clockwise or counterclockwise when viewed from above the air conditioner.

An air conditioner according to one aspect of the disclosure includes: a housing in which an inlet is formed; a blowing fan disposed in the housing and configured to generate an airflow; and an electrostatic precipitator disposed in the housing and configured to collect aerosols from air blown by the blowing fan, wherein the electrostatic precipitator includes: dust collection electrodes; a discharge electrode configured to generate ions toward the inlet and located upstream of the dust collection electrode; and a field-inducing electrode grounded to form an electric field with the discharge electrode and located upstream of the discharge electrode, and when a vertical distance from the discharge electrode to the inlet is a, and a horizontal distance from the discharge electrode to the inlet is b, a and b may satisfy the following relation:
0.3 < a/b < 1

An air conditioner according to one aspect of the disclosure includes: a housing in which an inlet is formed; a blowing fan disposed in the housing and configured to generate an airflow; and an electrostatic precipitator disposed in the housing and configured to collect aerosols from air blown by the blowing fan, wherein the electrostatic precipitator includes: a case; dust collection electrodes accommodated in the case; a discharge electrode configured to generate ions toward the inlet and located below the dust collection electrode within the case; a field-inducing electrode grounded to form an electric field with the discharge electrode and located below the discharge electrode within the case; and an air guide extending from the case toward the inlet to guide air flowing into the housing.

### DESCRIPTION OF DRAWINGS

FIG. 1 is a perspective view of an air conditioner according to an embodiment.

FIG. 2 is an enlarged view of the air conditioner according to an embodiment.

FIG. 3 is a cross-sectional view of the air conditioner according to an embodiment.

FIG. 4 is an enlarged view of the air conditioner according to an embodiment.

FIG. 5 is an exploded perspective view of the air conditioner according to an embodiment.

FIGS. 6A, 6B, 6C AND 6D illustrate an air flow in the air conditioner according to an embodiment.

FIGS. 7A, 7B AND 7C illustrate an air flow in the air conditioner according to an embodiment.

FIG. 8 is a cross-sectional view of the air conditioner according to an embodiment.

FIG. 9 is an enlarged view of the air conditioner according to an embodiment.

FIGS. 10A, 10B AND 10C illustrate an air flow in the air conditioner according to an embodiment.

FIGS. 11A AND ,11B illustrate an air flow in the air conditioner according to an embodiment.

FIGS. 12A AND, 12B illustrate an air flow in the air conditioner according to an embodiment.

FIG. 13 is a schematic diagram of a charging portion of the air conditioner according to an embodiment.

FIG. 14 is a schematic diagram of the air conditioner according to an embodiment.

FIG. 15 is a cross-sectional view of the air conditioner according to an embodiment.

FIG. 16 is an enlarged view of the air conditioner according to an embodiment.

FIG. 17 is a perspective view of the air conditioner according to an embodiment.

FIG. 18 is a perspective view of the air conditioner according to an embodiment.

FIG. 19 is a bottom view of the air conditioner according to an embodiment.

FIG. 20 is an enlarged view of the air conditioner according to an embodiment.

FIG. 21 is a perspective view of the air conditioner according to an embodiment.

### MODES OF THE DISCLOSURE

The embodiments described in the disclosure and the configurations shown in the drawings are only examples of the disclosure, and various modifications may be made at the time of filing of the disclosure to replace the embodiments and drawings of the disclosure.

In the description of the drawings, like numbers refer to like elements throughout the description of the drawings.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the disclosure, and do not exclude the presence or addition of one or more other features, numbers, steps, operations, elements, parts, or combinations thereof.

In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase of the phrases, or any possible combination thereof.

The term “and/or” includes combinations of one or all of a plurality of associated listed items.

It will be understood that, although the terms first, second, etc. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

In addition, the meaning of “identical” or “same” in the disclosure may include having similar properties or similarity within a certain range. In addition, “identical” or “same” refers to “substantially identical”. It should be understood that the meaning of “substantially identical” refers to a value that falls within an error range in manufacturing or a value having a difference within a range that does not have significance with respect to a reference value.

The terms, such as “~ part”, “~device”, “~block”, “~member”, “~ module”, and the like may refer to a unit for processing at least one function or act. For example, the terms may refer to at least process processed by at least one hardware, such as a field-programmable gate array (FPGA) and/or application specific integrated circuit (ASIC), software stored in memories, or processors.

In the following description, the terms “front,” “rear,” “left,” and “ right,” are defined based on the directions illustrated in the drawings, but the terms need not restrict the shape and position of the respective components.

Hereinafter, embodiments of the present disclosure will be described in detail with reference to the accompanying drawings.

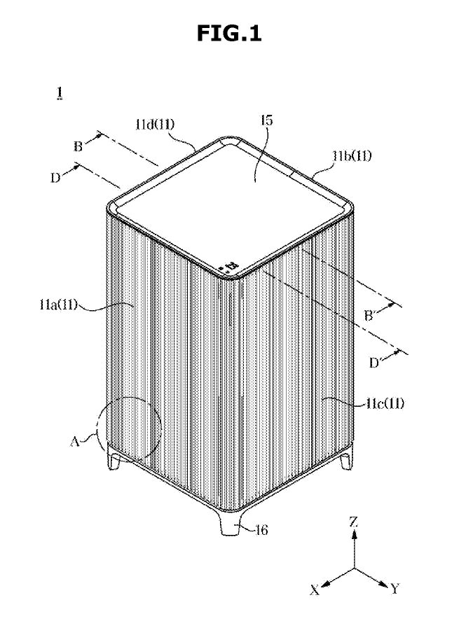

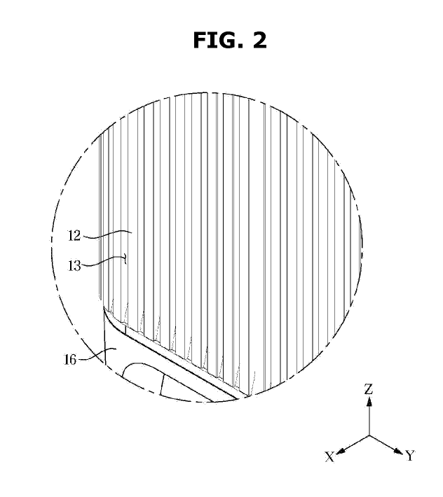

FIG. 1 is a perspective view of an air conditioner according to an embodiment. FIG. 2 is an enlarged view of the air conditioner according to an embodiment. FIG. 2 is an enlarged view of area A shown in FIG. 1.

Referring to FIGS. 1 and 2, an air conditioner 1 may include a housing 10. The housing 10 may form the exterior of the air conditioner 1.

The housing 10 may include an upper panel 15. The upper panel 15 may be provided at an upper portion of the housing 10. The upper panel 15 may be disposed above a blowing panel 11. A user display may be provided on the upper panel 15. For example, the user display may include a manipulation portion. The user display may receive a user input or output operating information of the air conditioner 1 to the user.

The housing 10 may include a support 16. The support 16 may be disposed at a lowermost side of the housing 10 to support the housing 10 and components constituting the air conditioner 1.

The housing 10 may include a blowing panel 11. The blowing panel 11 may include a first panel 11a, a second panel 11b, a third panel 11c, and a fourth panel 11d. The first panel 11a forms a front side of the air conditioner 1, the second panel 11b forms a rear side of the housing 10, and the third panel 11c and the fourth panel 11d form sides of the housing 10. The third panel 11c and the fourth panel 11d may connect the first panel 11a and the second panel 11b. The first panel 11a may be a front panel, the second panel 11b may be a rear panel, the third panel 11c may be a left panel, and the fourth panel 11d may be a right panel. The first panel 11a, the second panel 11b, the third panel 11c, and the fourth panel 11d may be integrally formed.

The blowing panel 11 may include a panel portion 12 and a blowing port 13.

The panel portion 12 may include a plurality of ribs. The plurality of ribs may extend in one direction. For example, the plurality of ribs may extend in the vertical direction. However, the disclosure is not limited thereto.

The panel portion 12 may be formed over the entire area of the blowing panel 11. The blowing panel 11 may be provided without a separately formed hole for exposing a discharge electrode 61 (see FIG. 2) inside the housing 10 to the outside. For example, the panel portion 12 may be provided in a uniform pattern over the entire area of the blowing panel 11. This increases the degree of freedom in designing the blowing panel 11 and may enhance aesthetics.

The blowing port 13 may be formed corresponding to the panel portion 12. For example, the blowing port 13 may be an opening formed between the plurality of ribs of the panel portion 12. Air outside the housing 10 may be drawn into the housing 10 or discharged from the housing 10 through the blowing port 13. The blowing port 13 may include a plurality of openings.

The air conditioner 1 may include the blowing port 13. For example, the blowing panel 11 may be provided with the blowing port 13 such that outside air flows into and out of the air conditioner 1. The blowing port 13 may extend in the vertical direction. The blowing port 13 may be formed in plural. The plurality of blowing ports 13 may be arranged in a direction perpendicular to the vertical direction. For example, the plurality of blowing ports 13 may be arranged in a left-right direction or in a front-rear direction.

Air blown through the blowing fan 30 may pass through the blowing port 13. The blowing port 13 may include a first inlet 13a and an outlet 13b. The first inlet 13a may be located upstream of the outlet 13b. The outlet 13b may be located downstream of the first inlet 13a. Air may pass through the housing 10. Air introduced into the housing 10 through the first inlet 13a may pass through the blowing fan 30 and flow to the outside of the housing 10 through the outlet 13b.

The first inlet 13a may be provided below the outlet 13b. The outlet 13b may be provided above the first inlet 13a. However, the positions of the first inlet 13a and the outlet 13b are not limited to the above examples.

The first inlet 13a and the outlet 13b may be formed in each of the first panel 11a, the second panel 11b, the third panel 11c, and the fourth panel 11d. For example, the first inlet 13a and the outlet 13b may be formed on a front surface, a rear surface, a left surface, and a right surface of the housing 10.

For example, air outside the housing 10 may flow into the housing 10 from various directions through the first inlet 13a. For example, air outside the housing 10 may flow into the housing 10 through the first inlet 13a from all directions. Also, for example, air inside the housing 10 may flow out of the housing 10 in various directions through the outlet 13b. For example, air inside the housing 10 may flow out of the housing 10 through the outlet 13b in all directions.

Therefore, since air is drawn in from all directions, air circulation inside the housing 10 may be facilitated, and the electrostatic precipitator and the air conditioner including the same may achieve high dust collection efficiency.

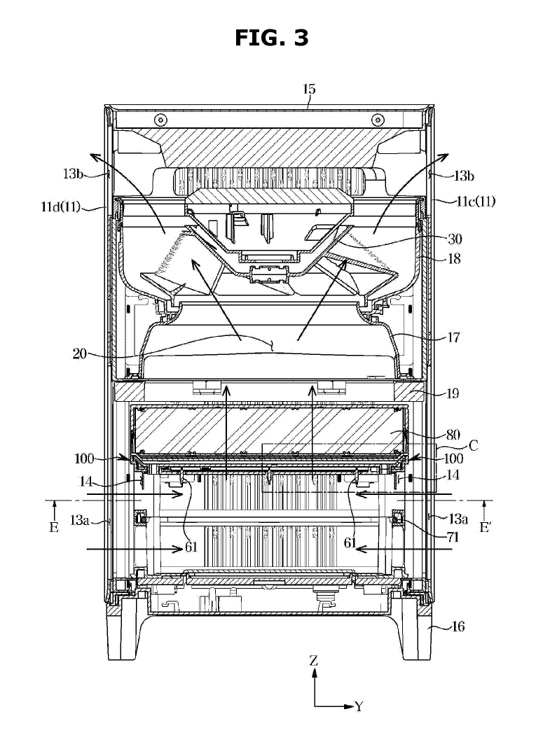

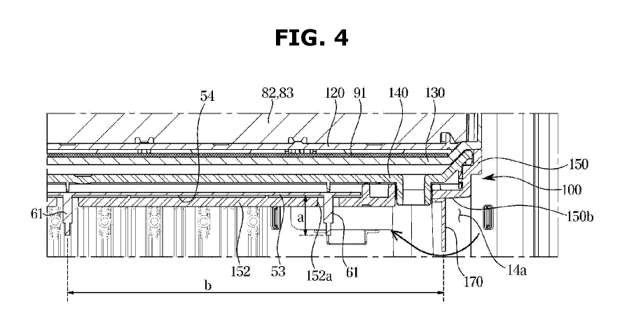

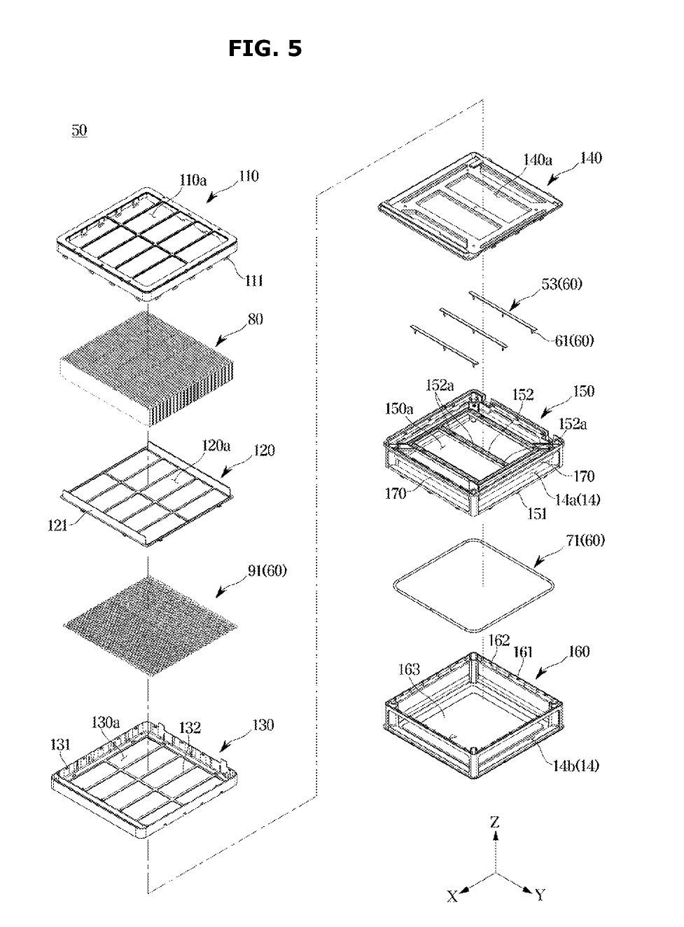

FIG. 3 is a cross-sectional view of the air conditioner according to an embodiment. FIG. 4 is an enlarged view of the air conditioner according to an embodiment. FIG. 5 is an exploded perspective view of the air conditioner according to an embodiment.

FIG. 3 is a cross-sectional view of the air conditioner shown in FIG. 1, taken along line B-B'. FIG. 4 is an enlarged view of region C shown in FIG. 3.

Referring to FIGS. 3 through 5, the air conditioner 1 may include a blowing fan 30. The blowing fan 30 may be located downstream of the first inlet 13a and upstream of the outlet 13b. The blowing fan 30 may be located at an upper portion inside the housing 10. The blowing fan 30 may rotate to generate an airflow inside the housing 10.

Air may pass through the housing 10 along an airflow direction. The airflow direction may be a direction from an upstream side to a downstream side in an air passage 20. The airflow direction may be a direction in which air enters the interior of the housing 10 through the first inlet 13a and the second inlet 14, then passes through an electrostatic precipitator 50 and the blowing fan 30 toward the outlet 13b. For example, the airflow direction may be a direction in which air enters the interior of the housing 10 through the first inlet 13a and the second inlet 14, then passes through the electrostatic precipitator 50 and the blowing fan 30. For example, air drawn in from the front, rear, left, and right sides of the housing 10 by the blowing fan 30 may flow upward and then be discharged from the front, rear, left, and right sides of the housing 10. However, the airflow direction is not limited to the above examples.

Air may be introduced into the housing in a second direction and then flow in a first direction within the housing. For example, the first direction may be a vertical direction and the second direction may be a horizontal direction.

The housing 10 may include an intermediate guide 17. Air that has flowed into the housing 10 through the inlet may be guided toward the blowing fan 30 through the intermediate guide 17. The intermediate guide 17 may form part of the passage 20 internally. The intermediate guide 17 may guide air inside the housing 10 and/or in the passage 20 to the blowing fan 30. Air passing through the interior of the intermediate guide 17 may flow into a fan housing 18 and to the blowing fan 30.

The housing 10 may include the fan housing 18. The blowing fan 30 may be disposed inside the fan housing 18. The fan housing 18 may form part of the passage 20 therein. The fan housing 18 may guide the flow of air flowing inside the housing 10. The fan housing 18 may communicate with the intermediate guide 17. The fan housing 18 may be disposed above the intermediate guide 17.

The blowing fan 30 may be disposed inside the fan housing 18. The fan housing 18 may form part of the passage 20 therein. The fan housing 18 may guide the flow of air flowing inside the housing 10. The fan housing 18 may communicate with the intermediate guide 17.

The housing 10 may include a fixing member 19. The fixing member 19 may allow a case 100 and the electrostatic precipitator 50 to be fixed inside the housing 10. For example, the fixing member 19 may be coupled to the blowing panel 11 and the case 100 to fix the case 100 inside the housing 10. The fixing member 19 may be disposed between the case 100 and the intermediate guide 18. Part of the passage 20 may be formed inside the fixing member 19.

The housing 10 may include the case 100. The case 100 may fix the electrostatic precipitator 50 inside the housing 10. The case 100 may be disposed outside the electrostatic precipitator 50. A second inlet 14 may be formed in the case 100. The case 100 may be included in the electrostatic precipitator 50.

The housing 10 may include the air passage 20 formed therein. The electrostatic precipitator 50 and the blowing fan 30 may be positioned on the passage 20. The passage 20 may include the first inlet 13a, the second inlet 14, and the outlet 13b. Air blown by the blowing fan 30 may flow through the passage 20. For example, air that has passed through the first inlet 13a may flow to the second inlet 14, and air that has entered the interior of the passage 20 through the second inlet 14 may flow to the outlet 13b after passing through the electrostatic precipitator 50. Air that has flowed to the outlet 13b may exit the passage 20.

Air outside the housing 10 may flow into the housing 10 from various directions through the second inlet 14. For example, air outside the housing 10 may flow into the housing 10 through the second inlet 14 from all directions. Also, for example, air inside the housing 10 may flow out of the housing 10 in various directions through the outlet 13b. For example, air inside the housing 10 may flow out of the housing 10 through the outlet 13b in all directions.

In one embodiment, the first inlet 13a and the second inlet 14 are described as separate elements, but the first inlet 13a and the second inlet 14 may be a single element.

The air conditioner 1 may include the electrostatic precipitator 50. The electrostatic precipitator 50 may be disposed inside the housing 10. For example, the electrostatic precipitator 50 may be fixed inside the housing 10 by the case 100. The electrostatic precipitator 50 may collect aerosols in the air to filter the air.

The electrostatic precipitator 50 may be disposed between the second inlet 14 and the outlet 13b. For example, the electrostatic precipitator 50 may be located downstream of the second inlet 14 and upstream of the outlet 13b. The electrostatic precipitator 50 may filter air that has been moved by the blowing fan 30 and drawn into the housing 10 through the first inlet 13a and the second inlet 14. The filtered air may be discharged to the outside of the housing 10 through the outlet 13b.

The electrostatic precipitator 50 may include a charging portion 60 and a dust collection portion 80. The charging portion 60 may charge aerosols in the air. The dust collection portion 80 may collect aerosols charged by the charging portion 60 and remove the collected aerosols from the air. The charging portion 60 may be disposed upstream of the dust collection portion 80.

The air conditioner 1 may include various filter devices (not shown) in addition to the electrostatic precipitator 50. For example, For example, a fine dust filter in the form of a nonwoven fabric formed of polypropylene resin or polyethylene resin and/or a granular activated carbon filter may be selectively provided.

The charging portion 60 may include a discharge electrode 61. The discharge electrode 61 may be disposed inside the housing 10. The discharge electrode 61 may generate ions. For example, the discharge electrode 61 may receive a high voltage from a power supply to emit electrons, and ions may be generated by corona discharge as the electrons collide with air molecules. The discharge electrode 61 may emit electrons upon reception of a voltage and may generate negative or positive ions in relation to air molecules. For example, a voltage of 2,000 V to 20,000 V may be applied to the discharge electrode 61.

The discharge electrode 61 may be arranged toward the second inlet 14 to generate ions. The discharge electrode 61 may emit electrons toward an upstream side of the air passage 20. Ions generated by collisions of electrons emitted from the discharge electrode 61 with air molecules may move in a direction opposite to the airflow direction.

The discharge electrode 61 may include a brush. The brush may include a plurality of conductive fibers. The conductive fibers may be formed of, for example, carbon fibers or the like. For example, the discharge electrode 61 may be formed of a material having electrical conductivity of 10% International Annealed Copper Standard (IACS) or more and 110% IACS or less.

The discharge electrode 61 may have an aspect ratio of 2:1 or more and 100:1 or less. For example, a ratio of a length in a Z-direction to a length in a Y-direction of the discharge electrode 61 may be 2 or more and 100 or less.

When a voltage is applied to the discharge electrode 61, corona discharge may occur at the discharge electrode 61. The discharge electrode 61 may generate electrons and generate ions in relation to air molecules.

For example, when a negative electrode is applied to the discharge electrode 61 and the discharge electrode 61 generates negative ions, the negative ions may charge aerosols to a negative polarity. When a positive electrode is applied to the discharge electrode 61 and the discharge electrode 61 generates positive ions, the positive ions may charge aerosols to a positive polarity. In the drawings, the discharge electrode 61 generating negative ions is shown as an example, but the disclosure is not limited thereto. For example, the discharge electrode 61 may also generate positive ions.

The discharge electrode 61 may include a plurality of discharge electrodes 61. The plurality of discharge electrodes 61 may be spaced apart from each other. Although nine discharge electrodes 61 are shown in the drawings as an example, the number of discharge electrodes 61 is not limited thereto.

The charging portion 60 may include a printed circuit board 53. The printed circuit board 53 may be electrically connected to the discharge electrode 61 to cause the discharge electrode 61 to emit electrons. The printed circuit board 53 may extend in one direction and be electrically connected to the plurality of discharge electrodes 61. The printed circuit board 53 may include a plurality of printed circuit boards 53. The plurality of printed circuit boards 53 may be spaced apart from each other in a direction different from the direction in which the plurality of printed circuit boards 53extend.

The charging portion 60 may include a field-inducing electrode 71. The field-inducing electrode 71 may induce an electric field with the discharge electrode 61. The field-inducing electrode 71 may be disposed upstream of the discharge electrode 61 with respect to the airflow direction. In addition, the field-inducing electrode 71 may be an upstream electrode 71. The field-inducing electrode 71 may be disposed between the second inlet 14 and the discharge electrode 61. The field-inducing electrode 71 may be disposed closer to the second inlet 14 than to the outlet 13b.

At least a portion of the field-inducing electrode 71 may include a conductive material. At least a portion of the field-inducing electrode 71 may include metal. At least a portion of the field-inducing electrode 71 may include metal or a conductive material that exhibits similar electrical characteristics.

The field-inducing electrode 71 may be grounded. For example, the field-inducing electrode 71 may maintain a voltage of approximately 0 V. The field-inducing electrode 71 may maintain a lower potential than the discharge electrode 61. Therefore, a constant potential difference may be formed between the field-inducing electrode 71 and the discharge electrode 61. An electric field may be formed between the field-inducing electrode 71 and the discharge electrode 61. High-density ions may be generated between the discharge electrode 61 and the field-inducing electrode 71.

The field-inducing electrode 71 may include an electrode portion 72. Part or all of the electrode portion 72 may include a conductive material. Part or all of the electrode portion 72 may include metal. At least a portion of the electrode portion 72 may include metal or a conductive material exhibiting similar electrical characteristics.

Since the field-inducing electrode 71 maintains a potential difference with the discharge electrode 61, corona discharge continuously occurs at the discharge electrode 61, and ions may be continuously generated.

By the interaction between the field-inducing electrode 71 and the discharge electrode 61, charging may occur inside the housing 10. Ions generated from the discharge electrode 61 may charge aerosols in the air between the discharge electrode 61 and the field-inducing electrode 71.

Ions generated by the discharge electrode 61 may charge aerosols in the air in the space between the discharge electrode 61 and the field-inducing electrode 71. The charged aerosols may be collected by the dust collection portion 80.

The field-inducing electrode 71 may include a closed-loop shape. The field-inducing electrode 71 may have a polygonal ring shape. The electrode portion 72 may have a polygonal ring shape. The electrode portion 72 may be formed in a closed-loop shape to form an opening. Therefore, the opening may also have a polygonal shape. For example, the discharge electrode 61 may be disposed in the opening 75 formed by the field-inducing electrode 71.

The electrostatic precipitator 50 may include a dust collection portion 80. The dust collection portion 80 may include a first dust collection electrode 82 and a second dust collection electrode 83 (see FIG. 4). The first dust collection electrode 82 and the second dust collection electrode 83 may be alternately arranged in the front-rear direction and/or the left-right direction. However, the disclosure is not limited thereto. For example, the first dust collection electrode 82 and the second dust collection electrode 83 may also be alternately arranged in the vertical direction.

The dust collection portion 80 may be electrically connected to the power supply. A high voltage may be applied to the first dust collection electrode 82 from the power supply, and the second dust collection electrode 83 may be grounded. A higher voltage may be applied to the first dust collection electrode 82 than to the second dust collection electrode 83, such that the first dust collection electrode 82 is formed as a positive (+) electrode and the second dust collection electrode 83 is formed as a negative (-) electrode. An electric field may be formed between the first dust collection electrode 82 and the second dust collection electrode 83, such that aerosols charged by the charging portion 60 may be collected by the dust collection electrodes 82 and 83.

The blowing panel 11 may be disposed upstream of the electrostatic precipitator 50 in the airflow direction, so as to shield the electrostatic precipitator 50 from being exposed to the outside of the housing 10. The panel portion 12 of the blowing panel 11 may shield the electrostatic precipitator 50. The panel portion 12 may be disposed upstream of the electrostatic precipitator 50 in the airflow direction.

The charging portion 60 may further include a ground electrode 91. The ground electrode 91 may be disposed downstream of the discharge electrode 61 with respect to the airflow direction. The ground electrode 91 may be a downstream electrode 91. The ground electrode 91 may be disposed between the discharge electrode 61 and the dust collection portion 80. The ground electrode 91 may be disposed adjacent to the dust collection portion 80.

The ground electrode 91 may be grounded. For example, the ground electrode 91 may maintain a voltage of approximately 0 V. The ground electrode 91 may maintain a lower potential than the discharge electrode 61. Therefore, a constant potential difference may be formed between the ground electrode 91 and the discharge electrode 61. An electric field may be formed between the ground electrode 91 and the discharge electrode 61. High-density ions may be generated between the discharge electrode 61 and the ground electrode 91.

The ground electrode 91 may include a mesh shape. The ground electrode 91 may include a plate shape. However, the disclosure is not limited thereto, and the ground electrode 91 may have the same shape as the field-inducing electrode 71.

Part or all of the ground electrode 91 may include a conductive material. Part or all of the ground electrode 91 may include metal. At least a portion of the ground electrode 91 may include metal or a conductive material exhibiting similar electrical characteristics.

Charging may occur by the interaction between the ground electrode 91 and the discharge electrode 61. Ions generated by the discharge electrode 61 may charge aerosols in the air between the discharge electrode 61 and the ground electrode 91.

Ions generated by the discharge electrode 61 may charge aerosols in the air in the space between the discharge electrode 61 and the ground electrode 91. The charged aerosols may be collected by the dust collection portion 80.

The ground electrode 91 may enhance an electric field downstream of the discharge electrode 61, increasing the efficiency with which aerosols are charged in the charging portion 60.

In addition, ions generated through the discharge electrode 61 may be removed while passing through the ground electrode 91, thereby preventing ions from accumulating in the dust collection electrodes 82 and 83. Therefore, it is possible to minimize the reduction in the strength of the electric field between the discharge electrode 61 and the field-inducing electrode 71 due to ion accumulation in the dust collection electrodes 82 and 83.

The electrostatic precipitator 50 may include a case 100. The case 100 may accommodate the components of the electrostatic precipitator 50. The case 100 may form an accommodation space in which the components of the electrostatic precipitator 50 are accommodated. The case 100 may be disposed inside an interior formed by the plurality of blowing panels 11. Therefore, the discharge electrode 61, the field-inducing electrode 71, the ground electrode 91, the dust collection portion 80, and other components included in the electrostatic precipitator 50 are not exposed to the outside of the housing 10, such that the aesthetics of the air conditioner may be improved.

The case 100 may include dust collection portion cases 110, 120, and 130 and charging portion cases 140, 150, and 160. The dust collection portion cases 110, 120, and 130 may be configured to accommodate the dust collection electrodes 82 and 83, and may include communication holes 110a, 120a, 130a, 140a, and 150a through which air that has passed through the charging portion 60 passes. The charging portion cases 140, 150, and 160 may be configured to accommodate components for charging, such as the field-inducing electrode 71 and the discharge electrode 61, and may include the second inlet 14 through which air flows into the electrostatic precipitator 50. In the drawings, the dust collection portion cases 110, 120, and 130 and the charging portion cases 140, 150, and 160 are shown as separate elements, but the dust collection portion cases 110, 120, and 130 and the charging portion cases 140, 150, and 160 may also be integrally formed.

The dust collection portion cases 110, 120, and 130 may include a plurality of dust collection case portions 110, 120, and 130. The plurality of dust collection case portions 110, 120, and 130 may include a first dust collection case portion 110, a second dust collection case portion 120, and a third dust collection case portion 130. However, the plurality of dust collection case portions 110, 120, and 130 may be integrally formed into a single case.

The first dust collection case portion 110 may be disposed above the dust collection electrodes 82 and 83. The first dust collection case portion 110 may cover at least part of upper and side portions of the dust collection electrodes 82 and 83. The first dust collection case portion 110 may be disposed above the second dust collection case portion 120 and the third dust collection case portion 130. The first dust collection case portion 110 may be coupled to the third dust collection case portion 130. The first dust collection case portion 110 may include a coupling portion 111. The first dust collection case portion 110 and the third dust collection case portion 130 may be hook-coupled. The coupling portion 111 of the first dust collection case portion 110 may be hook-coupled to a coupling portion 131 of the third dust collection case portion 130. The dust collection electrodes 82 and 83 may be accommodated in a space formed by coupling the first dust collection case portion 110 and the third dust collection case portion 130.

The first dust collection case portion 110 may include a first communication hole 110a. The first dust collection case portion 110 may have the first communication hole 110a formed therein. Air that has passed through the dust collection electrodes 82 and 83 may flow toward the blowing fan 30 through the first communication hole 110a. The first communication hole 110a may be positioned and disposed upstream of the fan and downstream of the second inlet 14 in the passage 20.

The second dust collection case portion 120 may be disposed below the dust collection electrodes 82 and 83. The second dust collection case portion 120 may cover part of front and rear portions of the dust collection electrodes 82 and 83. The second dust collection case portion 120 may support the dust collection electrodes 82 and 83. The second dust collection case portion 120 may be disposed between the first dust collection case portion 110 and the third dust collection case portion 130. The second dust collection case portion 120 may be seated on the third dust collection case portion 130.

The second dust collection case portion 120 may include a second communication hole 120a. The second dust collection case portion 120 may have the second communication hole 120a formed therein. Air that has passed through the charging portion 60 may pass through the dust collection electrodes 82 and 83 through the second communication hole 120a. The second communication hole 120a may be positioned and disposed upstream of the blowing fan 30 and downstream of the second inlet 14 in the passage 20. In addition, the second communication hole 120a may be positioned and disposed upstream of the first communication hole 110a in the passage 20.

The third dust collection case portion 130 may be disposed below the dust collection electrodes 82 and 83. The third dust collection case portion 130 may cover part of front, rear, side, and lower portions of the dust collection electrodes 82 and 83. The third dust collection case portion 130 may support the dust collection electrodes 82 and 83. The third dust collection case portion 130 may be disposed below the first dust collection case portion 110 and the second dust collection case portion 120.

The third dust collection case portion 130 may be coupled to the first dust collection case portion 110. The third dust collection case portion 130 may include a coupling portion 131. The first dust collection case portion 110 and the third dust collection case portion 130 may be hook-coupled. The coupling portion 111 of the first dust collection case portion 110 may be hook-coupled to a coupling portion 131 of the third dust collection case portion 130. The dust collection electrodes 82 and 83 may be accommodated in a space formed by coupling the first dust collection case portion 110 and the third dust collection case portion 130.

The third dust collection case portion 130 may include an electrode seating portion 132. A ground electrode may be seated on the electrode seating portion 132.

The third dust collection case portion 130 may include a third communication hole 130a. The third dust collection case portion 130 may have the third communication hole 130a formed therein. Air that has passed through the charging portion 60 may pass through the dust collection electrodes 82 and 83 through the third communication hole 130a. The third communication hole 130a may be positioned and disposed upstream of the fan and downstream of the second inlet 14 in the passage 20. In addition, the third communication hole 130a may be positioned and disposed upstream of the first communication hole 110a and the second communication hole 120a in the passage 20.

The charging portion cases 140, 150, and 160 may include a plurality of charging case portions 140, 150, and 160. The plurality of charging case portions 140, 150, and 160 may include a first charging case portion 140, a second charging case portion 150, and a third charging case portion 160. However, the plurality of charging case portions 140, 150, and 160 may be integrally formed into a single case.

The first charging case portion 140 may be disposed above the discharge electrode 61, the printed circuit board 53, and the field-inducing electrode 71. The first charging case portion 140 may cover the discharge electrode 61 and the printed circuit board 53.

The first charging case portion 140 may have the printed circuit board 53 attached thereto. The first charging case portion 140 may be disposed above the second charging case portion 150 and the third charging case portion 160.

The first charging case portion 140 may include a fourth communication hole 140a. The first charging case portion 140 may have the fourth communication hole 140a formed therein. Air that has passed through the first inlet 13a and the second inlet 14 may flow to the dust collection electrodes 82 and 83 through the fourth communication hole 140a. The fourth communication hole 140a may be positioned and disposed upstream of the blowing fan 30 and downstream of the second inlet 14 in the passage 20.

The second charging case portion 150 may be disposed below the first charging case portion 140. The seated on second charging case portion 150 may have the printed circuit board 53 seated thereon. Also, the discharge electrode 61 may be inserted into the second charging case portion 150. The second charging case portion 150 may support the printed circuit board 53 and/or the discharge electrode 61. The second charging case portion 150 may be disposed between the first charging case portion 140 and the third charging case portion 160.

The second charging case portion 150 may be coupled to the third charging case portion 160. The second charging case portion 150 may include a coupling portion 151. The second charging case portion 150 and the third charging case portion 160 may be hook-coupled. The coupling portion 151 of the second charging case portion 150 may be hook-coupled to a coupling portion 161 of the third charging case portion 160. The field-inducing electrode 71 may be accommodated in a space formed by coupling the second charging case portion 150 and the third charging case portion 160.

The second charging case portion 150 may include a fifth communication hole 150a. The second charging case portion 150 may have the fifth communication hole 150a formed therein. Air that has passed through the first inlet 13a and the second inlet 14 may flow to the dust collection electrodes 82 and 83 through the fifth communication hole 150a. The fifth communication hole 150a may be positioned and disposed upstream of the blowing fan 30 and downstream of the second inlet 14 in the passage 20. In addition, the fifth communication hole 150a may be positioned and disposed upstream of the fourth communication hole 140a in the passage 20.

The second charging case portion 150 may include a board seating portion 152. The board seating portion 152 may be provided to correspond to the number and shape of the printed circuit boards 53. The board seating portion 152 may extend in one direction. The printed circuit board 53 may be seated on the board seating portion 152, and the discharge electrode 61 may pass through the board seating portion 152 and protrude toward the third charging case portion 160.

An electrode hole 152a may be formed in the board seating portion 152. The electrode hole 152a may allow the discharge electrode 61 to pass therethrough. For example, the discharge electrode 61 that has passed through the electrode hole 152a may protrude downward.

The third charging case portion 160 may be disposed below the second charging case portion 150. The third charging case portion 160 may have the field-inducing electrode 71 seated thereon. The third dust collection case portion 130 may support the field-inducing electrode 71. The third charging case portion 160 may be disposed below the first charging case portion 140 and the second charging case portion 150. The third charging case portion 160 may be coupled to the second charging case portion 150.

The third charging case portion 160 may include an inducing electrode seating portion 162. The inducing electrode seating portion 162 may be provided corresponding to the shape of the field-inducing electrode 71. The inducing electrode seating portion 162 may include a quadrangular shape. The field-inducing electrode 71 may be seated on the inducing electrode seating portion 162 and disposed between the second charging case portion 150 and the third charging case portion 160.

The third charging case portion 160 may include a bottom portion 163. The bottom portion 163 may prevent air that has entered the interior of the charging portion cases 140, 150, and 160 through the second inlet 14 from escaping downward.

Inlets may be formed in the second charging case portion 150 and the third charging case portion 160. For example, the second charging case portion 150 and the third charging case portion 160 may have the second inlet 14 formed on the sides thereof. The second inlet 14 may be formed on all four sides of the second charging case portion 150 and on all four sides of the third charging case portion 160. Therefore, air may flow into the interior of the charging portion cases 140, 150, and 160 from all four directions.

The electrostatic precipitator 50 may include an air guide 170. The air guide 170 may guide air flowing from the outside of the housing 10 into the interior of the housing 10. For example, the air guide 170 may guide air flowing into the case 100 downward. The air guide 170 may allow air flowing into the interior of the charging portion cases 140, 150, and 160 to be evenly dispersed. For example, the air guide 170 may cause air flowing into the interior of the charging portion cases 140, 150, and 160 to flow toward the discharge electrode 61 and the field-inducing electrode 71, thereby increasing charging efficiency. As the charging efficiency increases, the dust collection efficiency in the dust collection portion 80 may also increase.

The air guide 170 may be provided on a side of the second inlet 14. For example, air that has passed through the first inlet 13a may flow downward by the air guide 170 provided on the side of the second inlet 14, and then pass through the air guide 170 to flow into the interior of the charging portion cases 140, 150, and 160. The air guide 170 may include a guide device, a guide portion, a guide member, a guide panel, a guide vane, and the like.

For example, the second inlet 14 may include a first inlet portion 14a and a second inlet portion 14b, the first inlet portion 14a may be formed in the second charging case portion 150, and the second inlet portion 14b may be formed in the third charging case portion 160. The first inlet portion 14a may be closer to the discharge electrode 61 than the second inlet portion 14b may be.

The air guide 170 may close part of the second inlet 14. For example, the air guide 170 may close part of the first inlet portion 14a of the second inlet 14. For example, the air guide 170 may close 25% to 50% of the second inlet 14.

When a vertical distance from the discharge electrode 61 to the inlet 14a is a, and a horizontal distance from the discharge electrode to the inlet 14 is b, a/b may be greater than 0.3 and less than 1. For example, when a vertical distance from a connection surface 54 of the printed circuit board 53 with the discharge electrode 61 (or a bottom of the discharge electrode) to one end (e.g., a lower end) of the air guide 170 is a, and a horizontal distance from the discharge electrode 61 to the air guide 170 is b, a/b may be greater than 0.3 and less than 1. Also, for example, when a vertical distance from the printed circuit board 53 to one end (e.g., a lower end) of the air guide 170 is a, and a horizontal distance from the discharge electrode 61 to the air guide 170 is b, a/b may be greater than 0.3 and less than 1.

When a/b is greater than 0.3 and less than 1, smooth charging is possible while preventing the noise or energy consumption of the electrostatic precipitator from increasing due to pressure differences. In the drawings, b is shown as the distance from the discharge electrode 61 located at a middle of the plurality of discharge electrodes 61 to the air guide 170, but the distance from the discharge electrode 61 adjacent to the air guide 170 among the plurality of discharge electrodes 61 to the air guide 170 may also be b.

Since air flowing into the interior of the case 100 through the second inlet 14 flows into the interior of the case 100 while bypassing the air guide 170, the distance and time for which air passes through the space between the discharge electrode 61 and the field-inducing electrode 71 may be increased.

Therefore, the distance and time during which aerosols in the air flowing into the interior of the case 100 are charged with ions between the discharge electrode 61 and the field-inducing electrode 71 become longer, and the flow velocity of air flowing to the discharge electrode 61 and the dust collection portion 80 may be reduced, such that aerosols may be smoothly charged. For example, a large amount of aerosols in the air may be charged, and many aerosols may be collected in the dust collection portion 80.

Since air flowing into the interior of the charging portion cases 140, 150, and 160 may be evenly dispersed by the air guide 170, the charging efficiency of aerosols increases, and the concentration of aerosols at a specific point of the dust collection portion 80 may be minimized, thereby improving the dust collection efficiency of the dust collection portion 80 and also increasing the performance and lifespan.

The air guide 170 may be provided in the charging portion cases 140, 150, and 160. For example, the air guide 170 may be provided in the second charging case portion 150. For example, the air guide 170 may extend downward from an upper end 150b of the second charging case portion 150. For example, the air guide 170 may extend from a wall 150b of the second charging case portion 150 that forms the inlet 14. However, the disclosure is not limited thereto, and the air guide 170 may be separately prepared and then coupled to the charging portion cases 140, 150, and 160, or may be integrally formed with the charging portion cases 140, 150, and 160.

A plurality of air guides 170 may be provided, and the plurality of air guides 170 may be respectively provided on a front, a rear, and both sides of the second charging case portion 150.

However, the formation position of the air guide 170 is not limited to the above examples. For example, when the charging portion cases 140, 150, and 160 are integrally formed, the air guide 170 may extend from the wall forming the inlet 14 of the charging portion cases 140, 150, and 160 toward the inlet 14 to guide the direction of air.

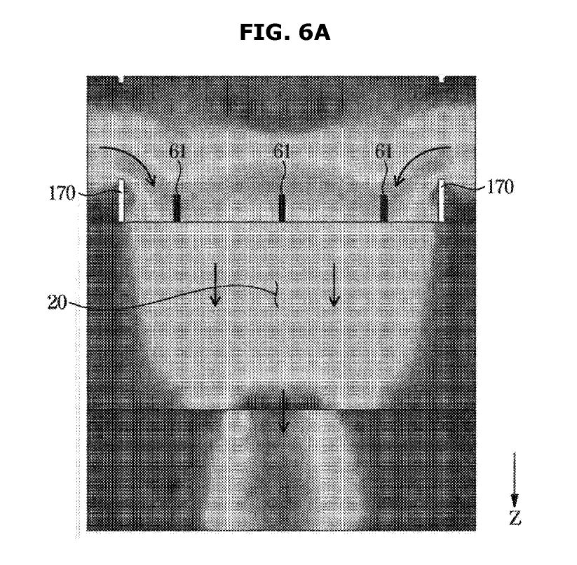

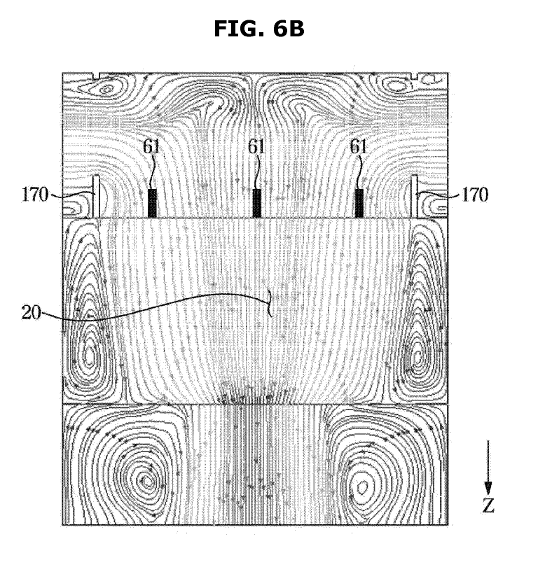

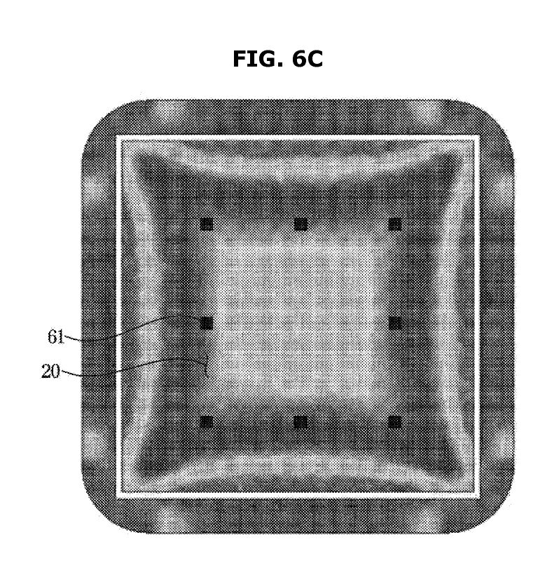

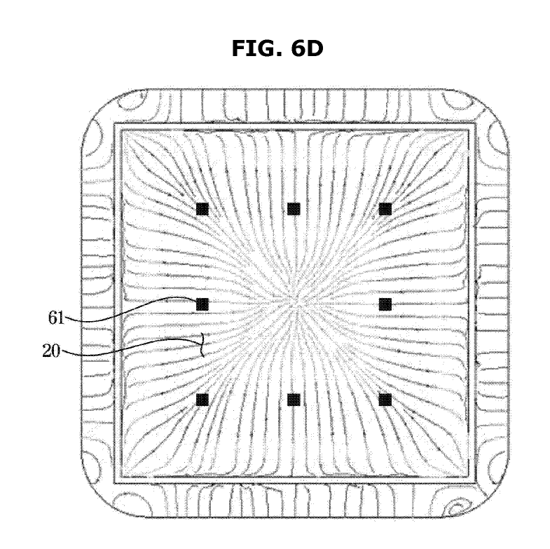

FIGS. 6A, 6B, 6C AND 6D illustrate an air flow in the air conditioner according to an embodiment. FIGS. 6A and 6B illustrate the airflow as seen in a cross-section of the air conditioner shown in FIG. 1 taken along line D-D', in which an upper portion of each of FIGS. 6A and 6B correspond to an inlet side. FIGS. 6C and 6D illustrate the airflow as seen in a cross-section of the air conditioner shown in FIG. 3 taken along line E-E'.

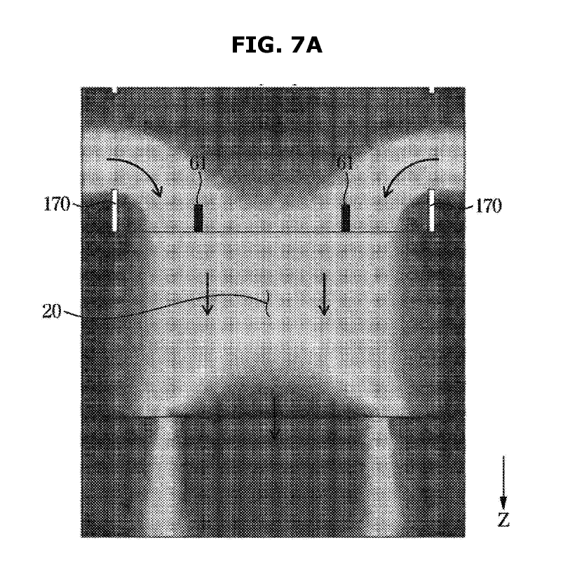

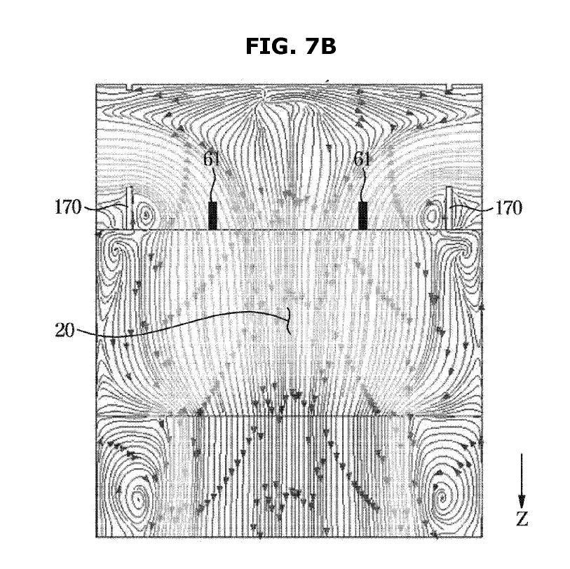

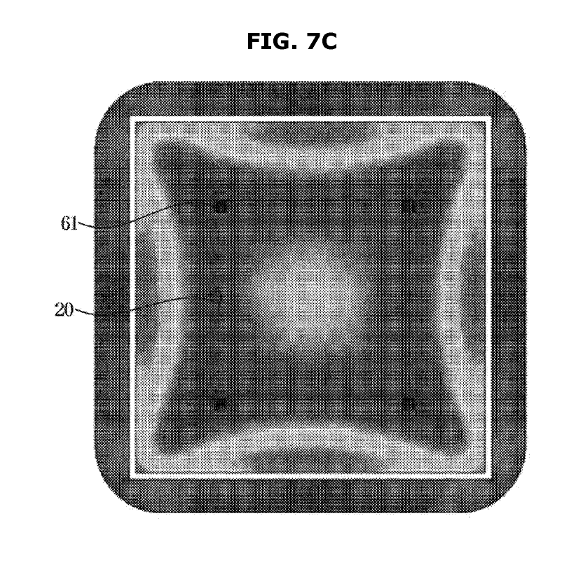

FIGS. 7A, 7B AND 7C illustrate an airflow in the air conditioner according to an embodiment. FIGS. 7A and 7B illustrate the airflow as seen in a cross section of the air conditioner shown in FIG. 1 taken along line B-B', in which an upper portion of each of FIGS. 7A and 7B corresponds to an inlet side. FIG. 7C illustrates the airflow as seen in a cross section of the air conditioner shown in FIG. 3 taken along line E-E'.

Referring to FIGS. 6A, 6B, 6C, 6D, 7A, 7B and 7C, air directed toward the passage 20 through the first inlet 13a and the second inlet 14 flows into the passage 20 while bypassing the air guide 170, so that the distance and time for which air passes through a space adjacent to the discharge electrode 61 may be increased. For example, since air directed toward the passage 20 through the inlets 13a and14 bypasses the air guide 170, the flow rate of air passing through the space adjacent to the discharge electrode 61 may increase.

Therefore, aerosols in the air flowing into the passage 20 may have am increased distance and time for being charged with ions between the discharge electrode 61 and the field-inducing electrode 71, and the flow velocity of air flowing to the discharge electrode 61 and the dust collection portion 80 may be reduced, such that aerosols may be smoothly charged. For example, a large amount of aerosols in the air may be charged, and many aerosols may be collected in the dust collection portion 80.

Since air flowing into the passage 20 may be evenly dispersed by the air guide 170, the charging efficiency of aerosols increases, and the concentration of aerosols at a specific point of the dust collection portion 80 may be minimized, thereby improving the dust collection efficiency of the dust collection portion 80 and also increasing the performance and lifespan.

Referring to FIGS. 6A, 6B, 6C, 6D, 7A, 7B and 7C, in an air conditioner including discharge electrodes 61 having different numbers and positions, airflows analyzed at different positions are illustrated. The air guide 170 is not limited to the number and position of the discharge electrodes 61 and the analysis position, and may increase the flow rate of air passing through the space adjacent to the discharge electrode 61.

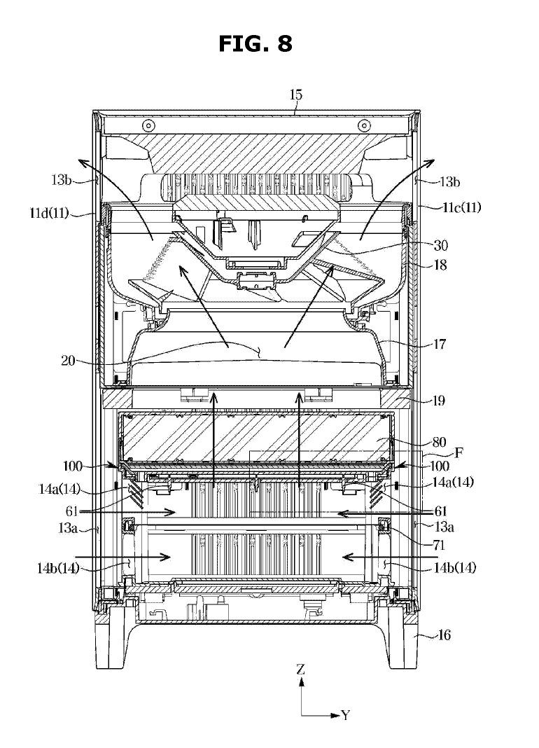

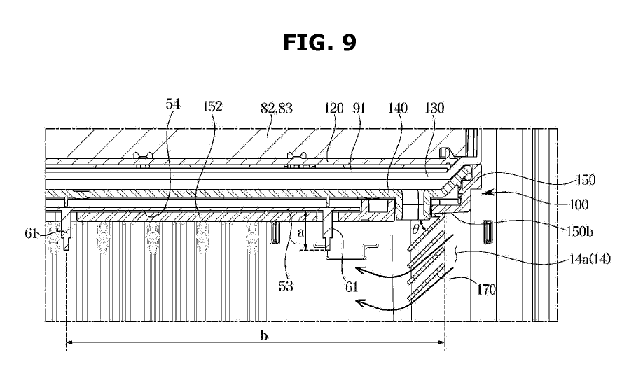

FIG. 8 is a cross-sectional view of the air conditioner according to an embodiment. FIG. 9 is an enlarged view of the air conditioner according to an embodiment.

Referring to FIGS. 8 and 9, the air guide 170 may have a predetermined angle with respect to the horizontal direction. The air guide 170 may be inclined downward toward the interior of the case 100. The air guide 170 may have an angle of 15 to 70 degrees with respect to the horizontal direction. For example, the air guide 170 may have an angle of 45 degrees with respect to the horizontal direction. Also, for example, the first air guide 170 may have an angle with respect to the walls 150b and 150c of the second charging case portion 150.

The air guide 170 may guide air flowing into the interior of the case 100 downward. The air guide 170 may allow air flowing into the interior of the charging portion cases 140, 150, and 160 to be evenly dispersed. For example, the air guide 170 may cause air flowing into the interior of the charging portion cases 140, 150, and 160 to flow toward the discharge electrode 61 and the field-inducing electrode 71, thereby increasing charging efficiency. As the charging efficiency increases, the dust collection efficiency in the dust collection portion 80 may also increase.

A plurality of air guides 170 may be provided. The plurality of air guides 170 may be spaced apart from each other. For example, the plurality of air guides 170 may be spaced apart in the vertical direction. Air flowing into the interior of the case 100 may pass between the plurality of air guides 170. The plurality of air guides 170 may be respectively provided at a front, a rear, and both sides of the second charging case portion 150.

Since air flowing into the case 100 through the second inlet 14 flows into the case 100 while bypassing the air guide 170, the distance and time for which air passes through the space between the discharge electrode 61 and the field-inducing electrode 71 may be increased.

Therefore, aerosols in the air flowing into the interior of the case 100 may have an increased distance and time for being charged with ions between the discharge electrode 61 and the field-inducing electrode 71, and the flow velocity of air flowing to the discharge electrode 61 and the dust collection portion 80 may be reduced, such that aerosols may be smoothly charged. For example, a large amount of aerosols in the air may be charged, and many aerosols may be collected in the dust collection portion 80.

Since air flowing into the interior of the charging portion cases 140, 150, and 160 may be evenly dispersed by the air guide 170, the charging efficiency of aerosols increases, and the concentration of aerosols at a specific point of the dust collection portion 80 may be minimized, thereby improving the dust collection efficiency of the dust collection portion 80 and also increasing the performance and lifespan.

The air guide 170 may be provided in the charging portion cases 140, 150, and 160. For example, the air guide 170 may be provided in the second charging case portion 150. For example, the air guide 170 may be coupled and connected to a side wall of the second charging case portion 150. For example, the air guide 170 may extend from a wall of the second charging case portion 150 that forms the inlet 14. For example, the plurality of air guides 170 may be arranged in the downward direction from an upper wall of the second charging case portion 150 forming the first inlet portion 14a of the second inlet 14. The plurality of air guides 170 may cover 20 to 100% of the second inlet 14.

However, the formation position of the air guide 170 is not limited to the above examples. For example, when the charging portion cases 140, 150, and 160 are integrally formed, the air guide 170 may extend from a wall forming the inlet 14 of the charging portion cases 140, 150, and 160 toward the inlet 14 to guide the direction of air.

The air guide 170 may include a flat surface. However, the disclosure is not limited thereto, and the air guide 170 may also include a curved surface.

When a vertical distance from a connection surface 54 of the printed circuit board 53 with the discharge electrode 61 (or a bottom of the discharge electrode) to one end (e.g., a lower end) of the air guide 170 is a, and a horizontal distance from the discharge electrode 61 to the air guide 170 is b, a/b may be greater than 0.3 and less than 1. Also, for example, when a vertical distance from the printed circuit board 53 to one end (e.g., a lower end) of the air guide 170 is a, and a horizontal distance from the discharge electrode 61 to the air guide 170 is b, a/b may be greater than 0.3 and less than 1.

When a/b is greater than 0.3 and less than 1, smooth charging is possible while preventing the noise or energy consumption of the electrostatic precipitator from increasing due to pressure differences. In the drawings, b is shown as the distance from the discharge electrode 61 located at a middle of the plurality of discharge electrodes 61 to the air guide 170, but the distance from the discharge electrode 61 adjacent to the air guide 170 among the plurality of discharge electrodes 61 to the air guide 170 may also be b.

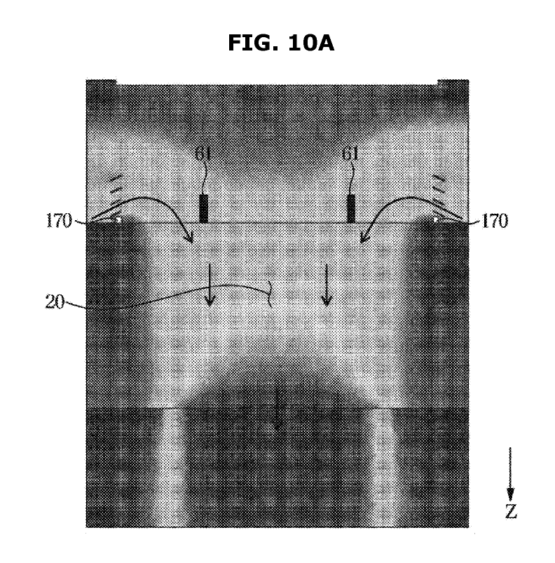

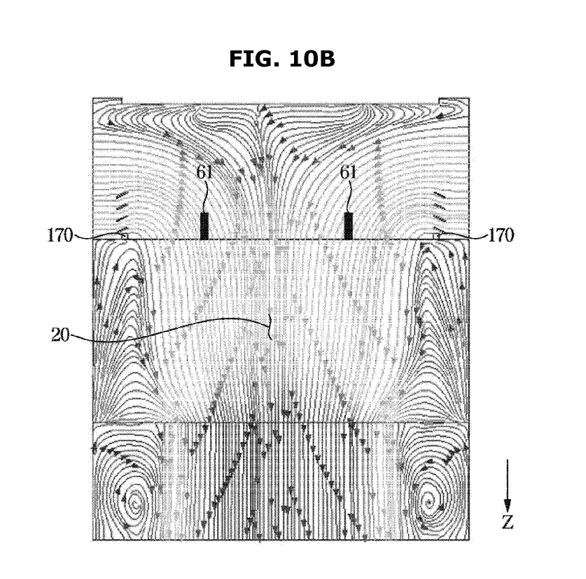

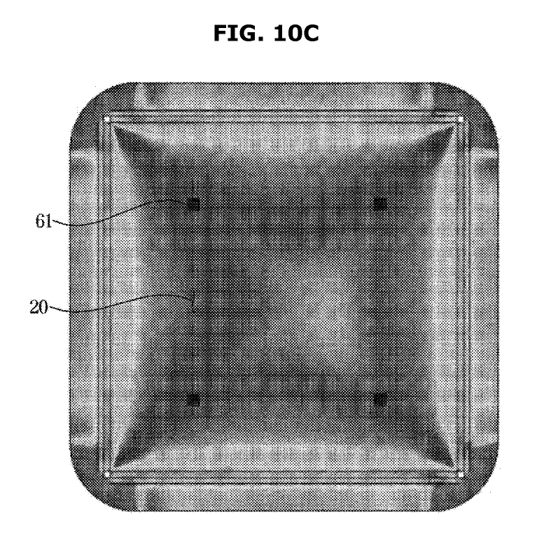

FIGS. 10A, 10B AND 10C illustrate an airflow in the air conditioner according to an embodiment. FIGS. 10A and 10B illustrate the airflow as seen in a cross section of the air conditioner shown in FIG. 1 taken along line B-B', in which an upper portion of each of FIGS. 10A and 10B corresponds to an inlet side. FIG. 10C illustrates the airflow as seen in a cross section of the air conditioner shown in FIG. 3 taken along line E-E'.

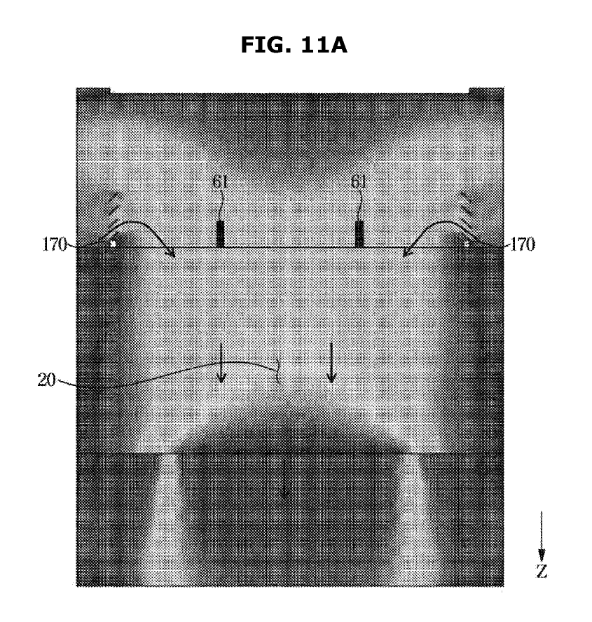

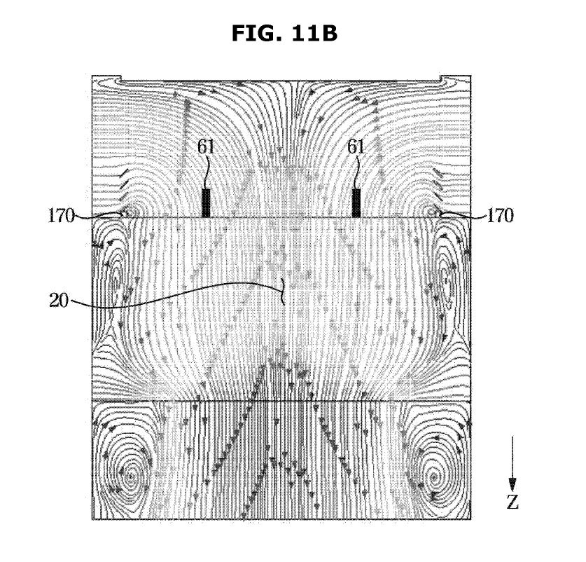

FIGS. 11A AND ,11B illustrate an airflow in the air conditioner according to an embodiment. FIGS. 11A and 11B illustrate the airflow as seen in a cross-section of the air conditioner shown in FIG. 1 taken along line B-B', in which an upper portion of each of FIGS. 11A and 11B corresponds to an inlet side.

FIGS. 10A, 10B AND 10C illustrate the air guide 170 having an angle of 26.5 degrees with respect to the horizontal direction, and FIGS. 11A AND,11B illustrate the air guide 170 having an angle of 45 degrees with respect to the horizontal direction.

Referring to FIGS. 10A, 10B, 10C, 11A and 11B, air directed toward the passage 20 through the first inlet 13a and the second inlet 14 flows into the passage 20 while bypassing the air guide 170, so that the distance and time for which air passes through a space adjacent to the discharge electrode 61 may be increased. For example, since air directed toward the passage 20 through the first inlet 13a and the second inlet 14 bypasses the air guide 170, the flow rate of air passing through the space adjacent to the discharge electrode 61 may increase.

Therefore, aerosols in the air flowing into the passage 20 may have an increased distance and time for being charged with ions between the discharge electrode 61 and the field-inducing electrode 71, and the flow velocity of air flowing to the discharge electrode 61 and the dust collection portion 80 may be reduced, such that aerosols may be smoothly charged. For example, a large amount of aerosols in the air may be charged, and many aerosols may be collected in the dust collection portion 80.

Since air flowing into the passage 20 may be evenly dispersed by the air guide 170, the charging efficiency of aerosols increases, and the concentration of aerosols at a specific point of the dust collection portion 80 may be minimized, thereby improving the dust collection efficiency of the dust collection portion 80 and also increasing the performance and lifespan.

Referring to FIGS. 10A, 10B, 10C, 11A and 11B, even when the angle of the air guide 170 with respect to the horizontal direction is varied, the flow rate of air passing through the space adjacent to the discharge electrode 61 increases, which may increase the dust collection efficiency.

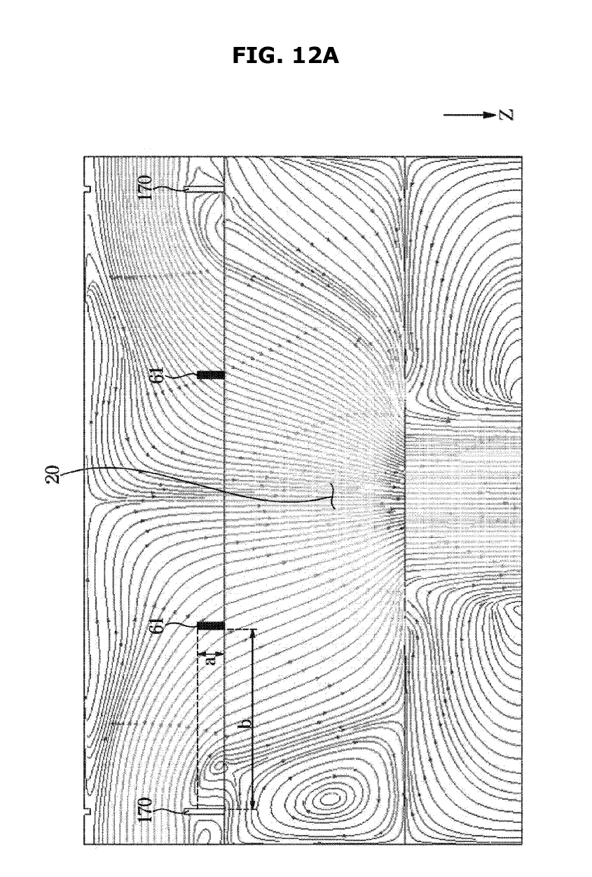

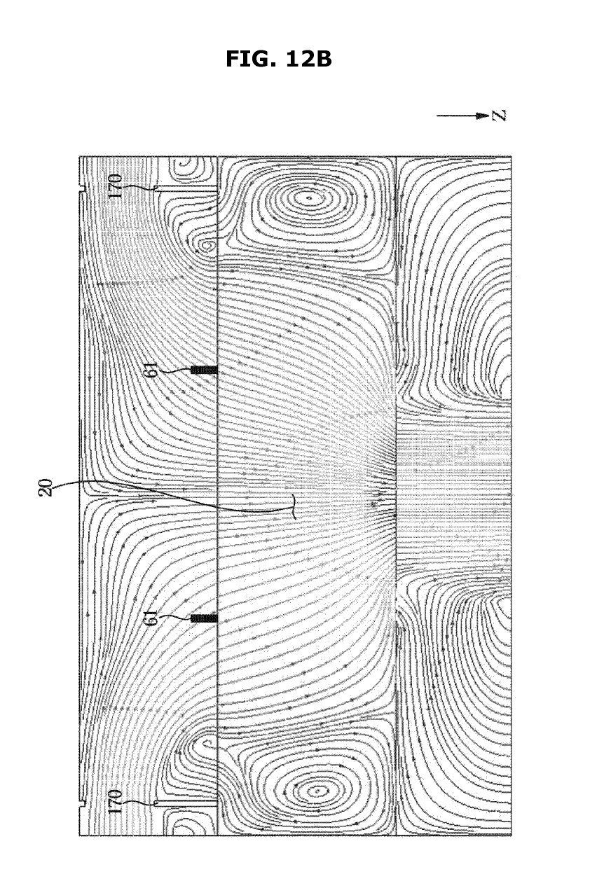

FIGS. 12A AND, 12B illustrate an air flow in the air conditioner according to an embodiment.

Referring to FIGS. 12A and 12B, air directed toward the passage 20 through the first inlet 13a and the second inlet 14 flows into the passage 20 while bypassing the air guide 170, so that the distance and time for which air passes through a space adjacent to the discharge electrode 61 may be increased. For example, since air directed toward the passage 20 through the first inlet 13a and the second inlet 14 bypasses the air guide 170, the flow rate of air passing through the space adjacent to the discharge electrode 61 may increase.

When a vertical distance from the discharge electrode 61 to the inlet 14a is a, and a horizontal distance from the discharge electrode to the inlet 14 is b, a/b may be greater than 0.3 and less than 1. For example, when a vertical distance from a connection surface 54 of the printed circuit board 53 with the discharge electrode 61 (or a bottom of the discharge electrode) to one end (e.g., a lower end) of the air guide 170 is a, and a horizontal distance from the discharge electrode 61 to the air guide 170 is b, a/b may be greater than 0.3 and less than 1. Also, for example, when a vertical distance from the printed circuit board 53 to one end (e.g., a lower end) of the air guide 170 is a, and a horizontal distance from the discharge electrode 61 to the air guide 170 is b, a/b may be greater than 0.3 and less than 1.

When a/b is greater than 0.3 and less than 1, smooth charging is possible while preventing the noise or energy consumption of the electrostatic precipitator from increasing due to pressure differences. In the drawings, b is shown as the distance from the discharge electrode 61 located at a middle of the plurality of discharge electrodes 61 to the air guide 170, but the distance from the discharge electrode 61 adjacent to the air guide 170 among the plurality of discharge electrodes 61 to the air guide 170 may also be b.

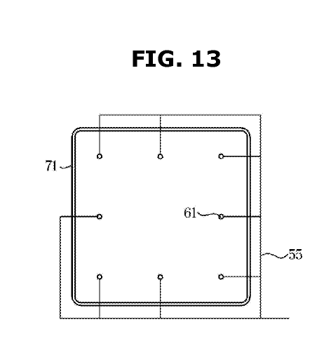

FIG. 13 is a schematic diagram of a charging portion of the air conditioner according to an embodiment.

Referring to FIG. 13, the plurality of discharge electrodes 61 may be directly connected to wires 55. For example, when there are nine discharge electrodes 61, the air conditioner 1 may be provided with nine wires 55 respectively connected to the discharge electrodes 61 and a wire 55 connected to an external power supply.

Alternatively, although not shown in the drawings, a plurality of printed circuit boards may be provided, a plurality of discharge electrodes may be electrically connected to each of the plurality of printed circuit boards, and wires may be connected to each of the plurality of printed circuit boards, or the plurality of printed circuit boards may be electrically connected to each other to supply power to the discharge electrodes.

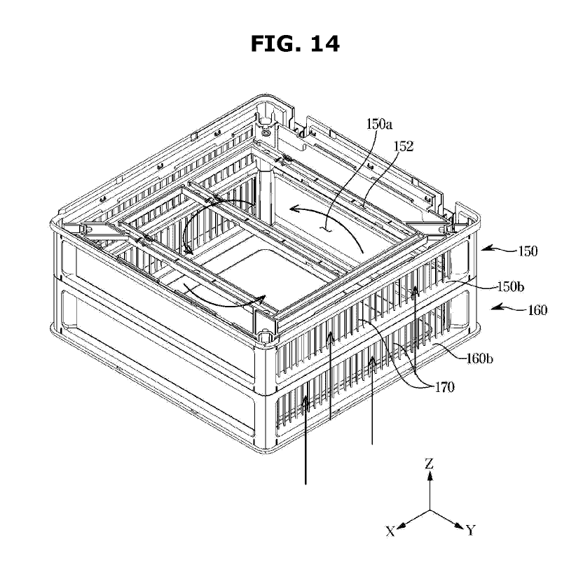

FIG. 14 is a schematic diagram of the air conditioner according to an embodiment.

Referring to FIG. 14, the air guide 170 may be provided in the charging portion cases 140, 150, and 160. For example, the air guide 170 may be provided in the second charging case portion 150 and/or the third charging case portion 160. The air guide 170 may be disposed at the first inlet portion 14a and the second inlet portion 14b of the second inlet 14 to guide air (see FIG. 8). For example, the air guide 170 may be connected to the wall 150b forming the inlet 14 of the second charging case portion 150. Also, for example, the air guide 170 may be connected to a wall 160b forming the inlet 14 of the third charging case portion 150. The air guide 170 may extend in the vertical direction.

The air guide 170 may include a plurality of air guides 170. The air guide 170 may guide air such that air introduced into the case 100 through the inlet 14 moves clockwise or counterclockwise when viewed from above the air conditioner.

The second charging case portion 150 and the third charging case portion 160 may be referred to as one charging case portion 150, 160. For example, inlets formed in the charging case portion 150, 160 may be provided on the left and right sides. The front and rear portions of the charging case portions 150, 160 may be closed.

The plurality of air guides 170 may be spaced a predetermined distance apart. For example, the plurality of air guides 170 may be spaced apart in the front-rear direction.

For example, the plurality of air guides 170 provided on the left side of the charging case portion 150, 160 may be increasingly inclined inward in a direction from front to rear. For example, the plurality of air guides 170 provided on the right side of the charging case portion 150, 160 may be increasingly inclined inward in a direction from rear to front.

In this case, air outside the charging case portion 150, 160 may flow from the front left to the rear inside the charging case portion 150, 160. Also, air outside the charging case portion 150, 160 may flow from the rear right to the front inside the charging case portion 150, 160.

Therefore, since air flowing into the charging case portion 150, 160 through the second inlet 14 flows into the charging case portions 150, 160 while bypassing the air guide 170, and does not directly flow toward the dust collection portion 80, the distance and time for the air to pass through the space between the discharge electrode 61 and the field-inducing electrode 71 may be increased.

As a result, aerosols in the air flowing into the case 100 may have an increased distance and time for being charged with ions between the discharge electrode 61 and the field-inducing electrode 71, and the flow velocity of air flowing to the discharge electrode 61 and the dust collection portion 80 may be reduced, such that aerosols may be smoothly charged. For example, a large amount of aerosols in the air may be charged, and many aerosols may be collected in the dust collection portion 80.

Meanwhile, inlets formed in the charging case portion 150, 160 may be provided at front and rear portions, and left and right sides may be closed. In this case, air outside the charging case portion 150, 160 may flow from the front to the left or right inside the charging case portion 150, 160, or may flow from the rear to the right or left inside the charging case portion 150, 160.

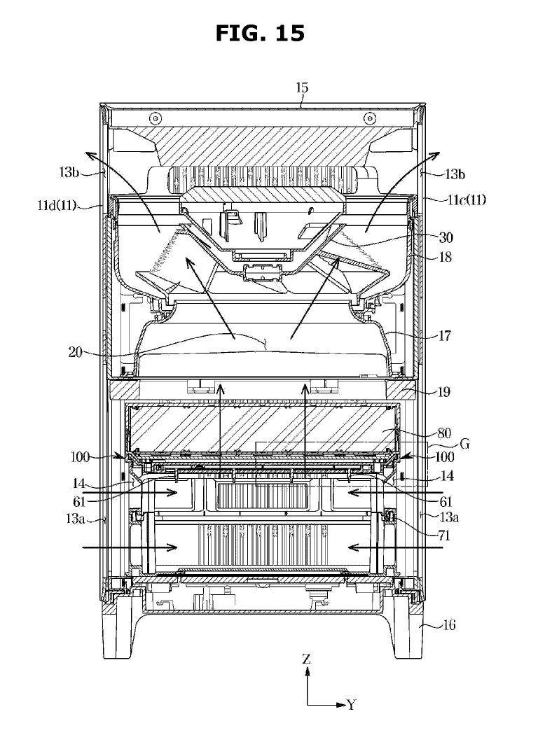

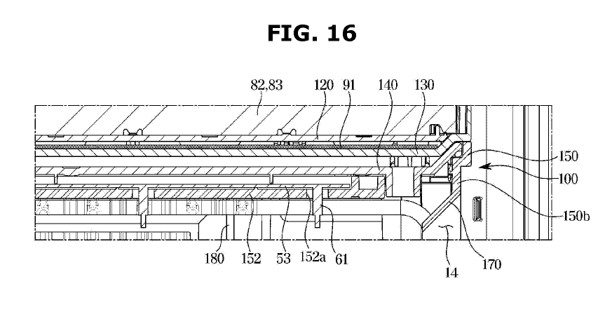

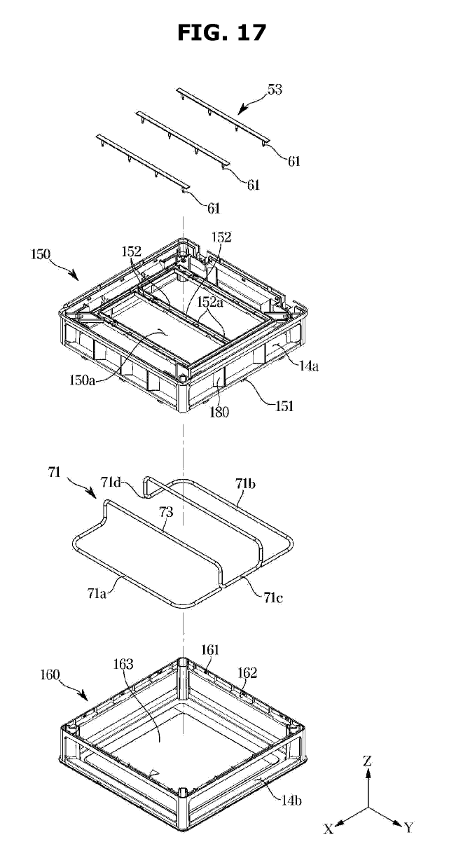

FIG. 15 is a cross-sectional view of an air conditioner according to an embodiment. FIG. 16 is an enlarged view of the air conditioner according to an embodiment. FIG. 16 is an enlarged view of a region G of FIG. 15. FIG. 17 is a perspective view of an air conditioner according to an embodiment.

Referring to FIGS. 15 through 17, the electrostatic precipitator 50 may include a discharge electrode 61 and a field-inducing electrode 71.

The discharge electrode 61 may be provided in plural. For example, four discharge electrodes 61 may be electrically connected to each of a plurality of printed circuit boards 53. The four discharge electrodes 61 may be arranged in the Y direction. The plurality of printed circuit boards 53 may be arranged in the X direction. By providing a plurality of discharge electrodes 61, the charging efficiency of aerosols in the charging portion 60 may be improved.

The field-inducing electrode 71 may include a planar portion 71a, 71b, 71c. The planar portion 71a, 71b, 71c may include a first side 71a, a second side 71b spaced apart from the first side 71a, a third side 71c connecting the first side 71a and the second side 71b between the first side 71a and the second side 71b, and a fourth side 71d between the first side 71a and the second side 71b. For example, a portion of the fourth side 71d may be open. The planar portion 71a, 71b, and 71c may be referred to as a horizontal portion 71a, 71b, 71c. The horizontal portion 71a, 71b, 71c may be disposed below the discharge electrode 61.

The field-inducing electrode 71 may further include a protrusion 73. The protrusion 73 may protrude from the planar portion 71a, 71b, 71c. For example, the protrusion 73 may be bent from the planar portion 71a, 71b, 71c and extend upward. The protrusion 73 may protrude from the horizontal portion71a, 71b, 71c toward the discharge electrode 61.

The protrusion 73 may include a plurality of protrusions 73. The plurality of protrusions 73 may be spaced apart. For example, the plurality of protrusions 73 may be spaced apart in the X direction. The plurality of protrusions 73 may be provided at the open portion of the fourth side 71d.

The plurality of protrusions 73 may be disposed between the first side 71a and the second side 71b of the planar portion 71a, 71b, 71c. For example, the first side 71a, the plurality of protrusions 73, and the second side 71b may be arranged along the X direction.

By providing the plurality of protrusions 73 in the field-inducing electrode 71, the charging efficiency of aerosols in the charging portion 60 may be improved.

The second charging case portion 150 may have the printed circuit board 53 seated thereon. Also, the second charging case portion 150 may have the discharge electrode 61 inserted thereto. The second charging case portion 150 may support the printed circuit board 53 and/or the discharge electrode 61.

The second charging case portion 150 may include a board seating portion 152. The printed circuit board 53 may be seated on the board seating portion 152, and the discharge electrode 61 may pass through the board seating portion 152 and protrude toward the third charging case portion 160.

The board seating portion 152 may include an electrode hole 152a. The discharge electrode 61 may pass through the electrode hole 152a. For example, the discharge electrode 61 that has passed through the electrode hole 152a may protrude downward.

The air conditioner may include a first air guide 170.

The first air guide 170 may have an angle with respect to the horizontal direction. The first air guide 170 may be inclined downward toward the interior of the case 100. The first air guide 170 may have an angle of 15 to 70 degrees with respect to the horizontal direction. For example, the first air guide 170 may have an angle of 45 degrees with respect to the horizontal direction. Also, for example, the first air guide 170 may have an angle with respect to the walls 150b and 150c of the second charging case portion 150.

The first air guide 170 may guide air flowing into the case 100 downward. The first air guide 170 may allow air flowing into the interior of the charging portion cases 140, 150, and 160 to be evenly dispersed. For example, the first air guide 170 may cause air flowing into the interior of the charging portion cases 140, 150, and 160 to flow toward the discharge electrode 61 and the field-inducing electrode 71, thereby increasing charging efficiency. As the charging efficiency increases, the dust collection efficiency in the dust collection portion 80 may also increase.

The first air guide 170 may be provided in plural. For example, the plurality of first air guides 170 may be provided at the front, rear, and both sides of the case 100.

Since air flowing into the case 100 through the second inlet 14 flows into the case 100 while bypassing the first air guide 170, the distance and time for which air passes through the space between the discharge electrode 61 and the field-inducing electrode 71 may be increased.

Therefore, aerosols in the air flowing into the case 100 may have an increased distance and time for being charged with ions between the discharge electrode 61 and the field-inducing electrode 71, and the flow velocity of air flowing to the discharge electrode 61 and the dust collection portion 80 may be reduced, such that aerosols may be smoothly charged. For example, a large amount of aerosols in the air may be charged, and more aerosols may be collected in the dust collection portion 80.

Since air flowing into the interior of the charging portion cases 140, 150, and 160 may be evenly dispersed by the first air guide 170, the charging efficiency of aerosols increases, and the concentration of aerosols at a specific point of the dust collection portion 80 may be minimized, thereby improving the dust collection efficiency of the dust collection portion 80 and also increasing the performance and lifespan.

The first air guide 170 may be provided in the charging portion cases 140, 150, and 160. For example, the air guide 170 may be provided in the second charging case portion 150. For example, the first air guide 170 may be coupled and connected to a side wall of the second charging case portion 150. For example, the air guide 170 may extend from a wall of the second charging case portion 150 that forms the inlet 14. For example, the plurality of first air guides 170 may be arranged in the downward direction from an upper wall of the second charging case portion 150 forming the first inlet portion 14a of the second inlet 14.

However, the formation position of the first air guide 170 is not limited to the above examples. For example, when the charging portion cases 140, 150, and 160 are integrally formed, the first air guide 170 may extend from a wall forming the inlet 14 of the charging portion cases 140, 150, and 160 toward the inlet 14 to guide the direction of air.

The first air guide 170 may include a flat surface. However, the disclosure is not limited thereto, and the first air guide 170 may also include a curved surface.

When a vertical distance from a connection surface 54 of the printed circuit board 53 with the discharge electrode 61 (or a bottom of the discharge electrode) to one end (e.g., a lower end) of the first air guide 170 is a, and a horizontal distance from the discharge electrode 61 to the first air guide 170 is b, a/b may be greater than 0.3 and less than 1. Also, for example, when a vertical distance from the printed circuit board 53 to one end (e.g., a lower end) of the first air guide 170, and a horizontal distance from the discharge electrode 61 to the first air guide 170 is b, a/b may be greater than 0.3 and less than 1.

When a/b is greater than 0.3 and less than 1, smooth charging is possible while preventing the noise or energy consumption of the electrostatic precipitator from increasing due to pressure differences. In the drawings, b is shown as the distance from the discharge electrode 61 located at a middle of the plurality of discharge electrodes 61 to the first air guide 170, but the distance from the discharge electrode 61 adjacent to the first air guide 170 among the plurality of discharge electrodes 61 to the first air guide 170 may also be b.

The air conditioner 1 may further include a second air guide 180.

The second air guide 180 may guide air flowing into the housing 10 to the discharge electrode 61, and accordingly, a large amount of air may flow toward the discharge electrode 61, improving the charging efficiency of aerosols in the charging portion 60.

The second air guide 180 may be provided in plural.

The plurality of second air guides 180 may be spaced apart from each other. For example, the plurality of air guides 180 may be spaced apart in the horizontal direction. Air flowing into the interior of the case 100 may pass between the plurality of second air guides 180. The plurality of second air guides 180 may be provided at the front, rear, and/or both sides of the second charging case portion 150.

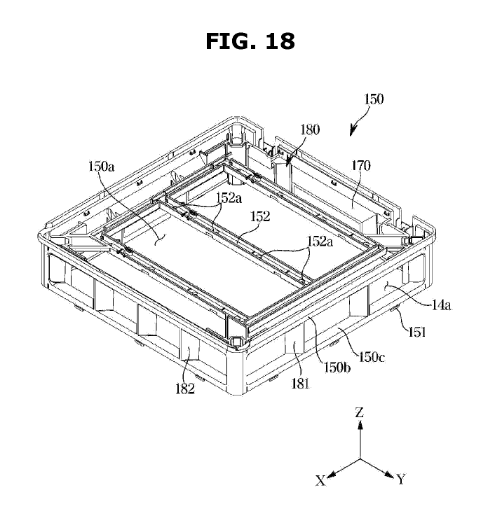

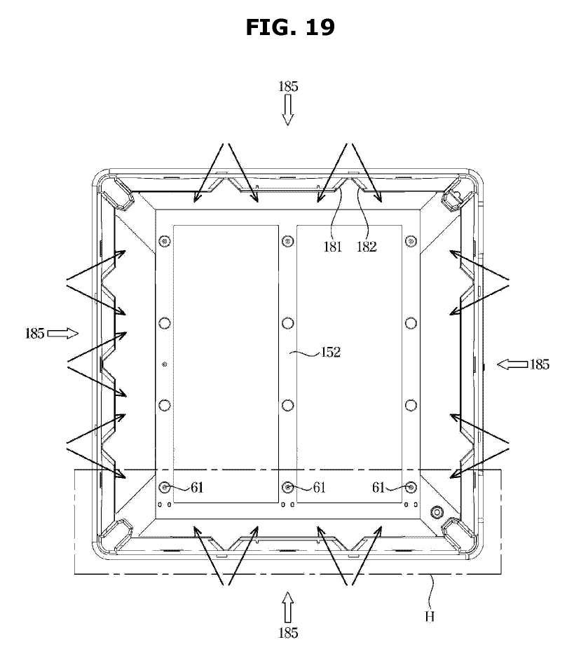

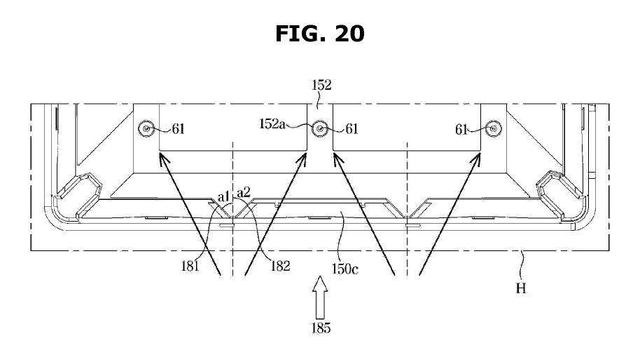

FIG. 18 is a perspective view of the air conditioner according to an embodiment. FIG. 19 is a bottom view of the air conditioner according to an embodiment. FIG. 20 is an enlarged view of the air conditioner according to an embodiment.

FIG. 18 is a perspective view of a second charging case portion of the air conditioner shown in FIG. 17. FIG. 19 is a bottom view of the electrostatic precipitator shown in FIG. 18. FIG. 20 is an enlarged view of region H of the second charging case portion shown in FIG. 19.

FIGS. 19 and 20 illustrate a state in which a plurality of discharge electrodes 61 are seated in a board seating portion 152. For example, four discharge electrodes 61 may be inserted through a single board seating portion 152.

Referring to FIGS. 18 through 20, a second air guide 180 may be disposed between inner walls 150b and 150c of the second charging case portion 150. For example, the second air guide 180 may be disposed between an upper wall 150b and a lower wall 150c of the second charging case portion 150 forming an inlet 14a and may connect the upper wall 150b and the lower wall 150c. The second air guide 180 may extend in the vertical direction. The second air guide 180 may be integrally formed with the second charging case portion 150. However, the second air guide 180 may be formed as a separate member and detachably coupled to the second charging case portion 150.

Air may enter the housing 10 in a second direction 185. For example, air may flow into the housing 10 in the horizontal direction.

The second air guide 180 may deflect air flowing into the housing 10. The second air guide 180 may change a direction of air flowing into the housing 10.

The second air guide 180 may include a first guide portion 181 and a second guide portion 182. The first guide portion 181 and the second guide portion 182 may guide air flowing to the housing 10 and/or the second charging case portion 150 toward the discharge electrode 61. Therefore, since air flows to the discharge electrode 61, the charging efficiency of aerosols in the charging portion 60 may be improved.

The first guide portion 181 and the second guide portion 182 may have respective angles with respect to the second direction 185 in different directions. The first guide portion 181 may have an angle a1 with respect to the second direction 185. The second guide portion 182 may have an angle a2 with respect to the second direction 185. For example, the first guide portion 181 and the second guide portion 182 may form an angle of 90 degrees with each other. However, the angle formed by the first guide portion 181 and the second guide portion 182 is not limited to the above example.

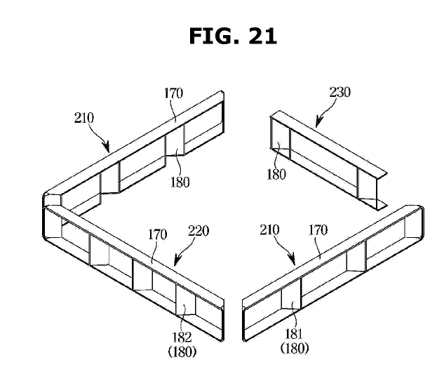

FIG. 21 is a perspective view of the air conditioner according to an embodiment.

Referring to FIG. 21, the electrostatic precipitator 50 may include a guide member 210, 220, 230. A first air guide 170 and/or a second air guide 180 may be formed and/or provided in the guide member 210, 220, 230. The guide member 210, 220, 230 may be coupled, mounted, and/or fixed to the case 100. For example, the guide member 210, 220, 230 may be coupled, mounted, and/or fixed to the second charging case portion 150. The guide member 210, 220, 230 may include a plurality of guide members 210, 220, and 230.

The first air guide 170 and the second air guide 180 may be formed and/or provided in each of the plurality of guide members 210, 220, and 230. The plurality of guide members 210, 220, and 230 may include a first guide member 210, a second guide member 220, and a third guide member 230.

The first guide member 210 may be formed longer than the third guide member 230. The first guide member 210 may include a plurality of first air guides 170 and/or second air guides 180. The first guide member 210 may include fewer air guides 170 and 180 than the second guide member 220.

The first guide member 210 may be provided in plural. The plurality of first guide members 210 may be coupled to the case 100 so as to face each other. The plurality of first guide members 210 may be coupled to the case 100 with the second guide member 220 and the third guide member 230 disposed therebetween.

The second guide member 220 may be formed longer than the third guide member 230. The second guide member 220 may include a plurality of first air guides 170 and/or second air guides 180. The second guide member 220 may include more air guides 170 and 180 than the first guide member 210 and the third guide member 230.

The third guide member 230 may be formed shorter than the first guide member 210 and the second guide member 220. The third guide member 230 may include the first air guide 170 and/or the second air guide 180. The third guide member 230 may include fewer air guides 170 and 180 than the first guide member 210 and the second guide member 220. In the drawings, only the second air guide 180 is shown in the third guide member 230, but the first air guide 170 may also be formed in the third guide member 230.

According to one aspect of the disclosure, an air conditioner may be provided with improved aerosol charging efficiency and dust collection efficiency because air directed toward the interior of the case is deflected through the air guide.

The effects of the disclosure are not limited to those described above, and other effects that are not described above will be clearly understood by those skilled in the art from the above detailed description and drawings.

An air conditioner according to an embodiment includes: a blowing fan 30; an electrostatic precipitator 50 including dust collection electrodes 82 and 83 configured to collect aerosols from air blown by the blowing fan, a discharge electrode 61 configured to emit electrons, located upstream of the dust collection electrode, and extending in a first direction, and a field-inducing electrode 71 grounded to form an electric field with the discharge electrode and located upstream of the discharge electrode; and a housing 10 configured to accommodate the blowing fan and the electrostatic precipitator, wherein the housing includes: a first surface 11a; a second surface 11b opposite to the first surface; a third surface 11c connecting the first surface and the second surface between the first and second surfaces; and a fourth surface 11d connecting the first surface and the second surface between the first and second surfaces and opposite to the third surface, wherein an inlet 13a, 14 is formed in each of the first surface, the second surface, the third surface, and the fourth surface of the housing, and when a distance in the first direction from one end of the discharge electrode to the inlet is a, and a distance in a second direction different from the first direction from the discharge electrode to the inlet is b, a and b may satisfy the following relation:
0.3 < a/b < 1

The air conditioner may further include an air guide 170 extending in the first direction and configured to deflect air drawn into the housing in the second direction through the inlet.

The electrostatic precipitator includes a printed circuit board 53 electrically connected to the discharge electrode at an upper side of the discharge electrode, and when a vertical distance from the printed circuit board to a lower end of the air guide is a, and a horizontal distance from the printed circuit board to the air guide is b, a and b may satisfy the following relation:
0.3 < a/b < 1

The inlet includes a first inlet 13a and a second inlet 14, and the housing further includes: a blowing panel 11 including the first inlet through which air moved by the blowing fan flows; and a case 100 configured to accommodate the electrostatic precipitator and including the second inlet through which air that has passed through the first inlet flows, wherein the air guide may extend from an inner wall 150b, 150c of the case that forms the second inlet toward the second inlet.

The air guide may extend from the inner wall of the case forming the second inlet toward an inside of the case in a downward inclined manner.

The air guide may have an angle of 15 to 70 degrees with respect to a horizontal direction.

The dust collection electrode may be disposed above the discharge electrode and the field-inducing electrode, the field-inducing electrode may be disposed below the discharge electrode, the discharge electrode may be disposed above the lower end of the air guide, and the printed circuit board may be disposed above the discharge electrode.

The air guide may be a first air guide, and the air conditioner may further include a second air guide 180 provided in the housing and configured to guide air, which is drawn into the housing in the second direction through the inlet, to the discharge electrode.

The second air guide may include a first guide portion 181 inclined with respect to the second direction to deflect air drawn in the second direction; and a second guide portion 182 inclined with respect to the second direction in a direction different from a direction of the first guide portion to deflect air drawn in the second direction.

The first direction may be a vertical direction and the second direction may be a horizontal direction.

The electrostatic precipitator may further include a ground electrode 91 located above the discharge electrode and below the dust collection electrode such that ions are attached thereto.

The ground electrode may be a first ground electrode, and the electrostatic precipitator may further include a second ground electrode 92 disposed below the field-inducing electrode.

The housing may further include a case 100 configured to accommodate the electrostatic precipitator and including the inlet 14, and the air guide may be configured such that air introduced into the case through the inlet moves clockwise or counterclockwise when viewed from above the air conditioner.

An air conditioner according to an embodiment includes: a housing 10 in which an inlet 13a, 14 is formed; a blowing fan 30 disposed in the housing and configured to generate an airflow; and an electrostatic precipitator 50 disposed in the housing and configured to collect aerosols from air blown by the blowing fan, wherein the electrostatic precipitator 50 includes: dust collection electrodes 82 and 83; a discharge electrode 61 configured to generate ions toward the inlet and located upstream of the dust collection electrode; and a field-inducing electrode 71 grounded to form an electric field with the discharge electrode and located upstream of the discharge electrode, and when a vertical distance from the discharge electrode to the inlet is a, and a horizontal distance from the discharge electrode to the inlet is b, a and b may satisfy the following relation:
0.3 < a/b < 1

The air conditioner may further include an air guide 170 provided in the housing and configured to deflect air flowing toward the discharge electrode through the inlet.

The electrostatic precipitator includes a printed circuit board 53 electrically connected to the discharge electrode at an upper side of the discharge electrode, and when a vertical distance from the printed circuit board to a lower end of the air guide is a, and a horizontal distance from the printed circuit board to the air guide is b, a and b may satisfy the following relation:
0.3 < a/b < 1

The inlet includes a first inlet 13a and a second inlet 14, and the housing further includes: a blowing panel 11 including the first inlet through which air moved by the blowing fan flows; and a case 100 configured to accommodate the electrostatic precipitator and including the second inlet through which air that has passed through the first inlet flows, wherein the air guide may extend from an inner wall of the case that forms the second inlet toward the second inlet.

An air conditioner according to an embodiment includes: a housing 10 in which an inlet 13a, 14 is formed; a blowing fan 30 disposed in the housing and configured to generate an airflow; and an electrostatic precipitator 50 disposed in the housing and configured to collect aerosols from air blown by the blowing fan, wherein the electrostatic precipitator 50 includes: a case 100; dust collection electrodes 82 and 83 accommodated in the case; a discharge electrode 61 configured to generate ions toward the inlet and located below the dust collection electrode within the case; a field-inducing electrode 71 grounded to form an electric field with the discharge electrode and located below the discharge electrode within the case; and an air guide 170 extending from the case toward the inlet to guide air flowing into the housing.

The electrostatic precipitator includes a printed circuit board 53 electrically connected to the discharge electrode at an upper side of the discharge electrode, and when a vertical distance from the printed circuit board to a lower end of the air guide is a, and a horizontal distance from the printed circuit board to the air guide is b, a and b may satisfy the following relation:
0.3 < a/b < 1

The inlet includes a first inlet 13a and a second inlet 14, the housing further includes a blowing panel 11 including the first inlet through which air moved by the blowing fan flows, and the air guide may extend from an inner wall of the case that forms the second inlet toward the second inlet.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An air conditioner comprising:
a blowing fan;
an electrostatic precipitator including:
a dust collection electrode configured to collect aerosols from air blown by the blowing fan;
a discharge electrode configured to emit electrons, the discharge electrode being located upstream of the dust collection electrode and extending in a first direction;
a field-inducing electrode grounded to form an electric field with the discharge electrode, the field-inducing electrode being located upstream of the discharge electrode; and
a housing configured to accommodate the blowing fan and the electrostatic precipitator,
wherein the housing includes:
a first surface;
a second surface opposite to the first surface;
a third surface connecting the first surface and the second surface; and
a fourth surface connecting the first surface and the second surface and opposite to the third surface,
wherein an inlet is formed in each of the first surface, the second surface, the third surface, and the fourth surface, and
wherein based on a distance in the first direction from one end of the discharge electrode to the inlet being a, and a distance in a second direction different from the first direction from the discharge electrode to the inlet being b, a and b satisfy the following relation:
0.3 < a/b < 1

2. The air conditioner of claim 1, further comprising:
an air guide extending in the first direction, the air guide being configured to deflect air drawn into the housing in the second direction through the inlet.

3. The air conditioner of claim 2, wherein the electrostatic precipitator
includes a printed circuit board electrically connected to the discharge electrode above the discharge electrode, and
wherein based on a vertical distance from the printed circuit board to a lower end of the air guide being a, and a horizontal distance from the printed circuit board to the air guide being b, a and b satisfy the following relation.
03 < a/b < 1

4. The air conditioner of claim 3, wherein the inlet includes:
a first inlet; and
a second inlet,
wherein the housing further includes:
a blowing panel including the first inlet through which air moved by the blowing fan flows; and
a case configured to accommodate the electrostatic precipitator and including the second inlet through which air that has passed through the first inlet flows, and
wherein the air guide extends from an inner wall of the case forming the second inlet toward the second inlet.

5. The air conditioner of claim 4, wherein the air guide extends from
the inner wall of the case forming the second inlet toward an inside of the case in a downwardly inclined manner.

6. The air conditioner of claim 5, wherein the air guide has an angle of
15 degrees to 70 degrees with respect to a horizontal direction.

7. The air conditioner of claim 6, wherein:
the dust collection electrode is disposed above the discharge electrode and the field-inducing electrode;
the field-inducing electrode is disposed below the discharge electrode;
the discharge electrode is disposed above the lower end of the air guide; and
the printed circuit board is disposed above the discharge electrode.

8. The air conditioner of claim 2, wherein the air guide is a first air
guide, and the air conditioner further includes a second air guide disposed in the housing and configured to guide air drawn into the housing in the second direction through the inlet, toward the discharge electrode.

9. The air conditioner of claim 8, wherein the second air guide includes:
a first guide portion inclined with respect to the second direction to deflect air drawn in the second direction, and
a second guide portion inclined with respect to the second direction in a direction different from a direction of the first guide portion to deflect air drawn in the second direction.

10. The air conditioner of claim 9, wherein the first direction is a
vertical direction and the second direction is a horizontal direction.

11. The air conditioner of claim 10, wherein the electrostatic
precipitator further includes a ground electrode disposed above the discharge electrode and below the dust collection electrode such that ions are attached the ground electrode.

12. The air conditioner of claim 11, wherein the ground electrode is a
first ground electrode, and the electrostatic precipitator further includes a second ground electrode disposed below the field-inducing electrode.

13. The air conditioner of claim 2, wherein the housing further includes
a case configured to accommodate the electrostatic precipitator and including the inlet, and the air guide is configured such that air introduced into the case through the inlet moves clockwise or counterclockwise when viewed from above the air conditioner.
